(19) United States
(12) Patent Application Publication
(10) Pub. No.: US 2025/0217101 A1
(43) Pub. Date: Jul. 3, 2025

(54) DISPLAY DEVICE FOR PROVIDING CONTENT, AND DISPLAY DEVICE OPERATION METHOD

(71) Applicant: SAMSUNG ELECTRONICS CO., LTD., Suwon-si (KR)

(72) Inventors: Minji Kim, Suwon-si (KR); Sukun Yoon, Suwon-si (KR); Deoknam Kim, Suwon-si (KR); Sangmin Kim, Suwon-si (KR); Jongha Woo, Suwon-si (KR); Yongjun Hong, Suwon-si (KR)

(73) Assignee: SAMSUNG ELECTRONICS CO., LTD., Suwon-si (KR)

(21) Appl. No.: 19/086,960

(22) Filed: Mar. 21, 2025

Related U.S. Application Data
(63) Continuation of application No. PCT/KR2023/014872, filed on Sep. 26, 2023.

(30) Foreign Application Priority Data
Sep. 28, 2022 (KR) 10-2022-0123779
Mar. 2, 2023 (KR) 10-2023-0027929

(51) Int. Cl. G06F 3/16; G06F 3/14; H04R 3/12

(52) U.S. Cl. CPC G06F 3/165; G06F 3/14; G06F 3/162; G06F 3/167; H04R 3/12; H04R 2430/01

(57) ABSTRACT

A display device includes a display, a speaker; a communication interface; memory storing instructions; and at least one processor, wherein the instructions, when executed, cause the display device to determine whether an external audio device is connected via the communication interface; based on the external audio device not being connected, operate in a first mode that displays a first image corresponding to content and outputs, via the speaker, a first sound corresponding to the content; based on the external audio device being connected, operate in a second mode that displays the first image and outputs the first sound from the external audio device via the communication interface; and based on operating in the second mode, in response to receiving a first control signal to stop outputting the first sound, display the first image, stop outputting the first sound via the communication interface, and mute the first sound.

### CROSS-REFERENCE TO RELATED APPLICATIONS

This application is a by-pass continuation application of International Application No. PCT/KR2023/014872, filed on Sep. 26, 2023, which is based on and claims priority to Korean Patent Application No. 10-2022-0123779, filed in the Korean Intellectual Property Office on Sep. 28, 2022, and Korean Patent Application No. 10-2023-0027929, filed in the Korean Intellectual Property Office on Mar. 2, 2023, the disclosures of which are incorporated by reference herein in their entireties.

### BACKGROUND

### 1. Field

The disclosure relates to a display device and an operation method thereof, and more particularly, to a display device providing content, and an operation method of the display device.

### 2. Description of Related Art

With developments in technology, in relation to content watching, in addition to speakers or other audio devices included in display devices, external audio devices that are connected to the display devices in a wired or wireless manner to provide sound of the content are being developed.

Compared to receiving sound from an audio device included in a display device, an external audio device may provide users with improved sound quality or protect their privacy by providing the sound of the content only to the users without providing the sound of the content to the outside.

Various technologies and techniques for showing virtual reality using computer graphics, for example, are being developed. Users may use their avatars to engage in activities in virtual reality, and may receive visually immersive virtual reality through display devices. Moreover, users can use their avatars within the virtual reality to communicate with other users who have access to the virtual reality.

### SUMMARY

According to an aspect of the disclosure, a display device for providing content includes a display; an audio device; a communication interface; memory storing instructions; and at least one processor, wherein the instructions, when executed by the at least one processor, cause the display device to determine whether the display device and an external audio device are connected via the communication interface; based on the display device not being connected to the external audio device, operate in a first mode that controls the display to display a first image corresponding to the content and controls the audio device to output a first sound corresponding to the content; based on the display device being connected to the external audio device, operate in a second mode that controls the display to display the first image and controls the communication interface to output the first sound via the external audio device; and based on operating in the second mode, in response to receiving a first control signal indicating a request to stop outputting the first sound via the external audio device, control the display to display the first image, control the communication interface to stop outputting the first sound via the external audio device, and mute the first sound.

The first control signal may be generated from at least one of an electronic device connected to the external audio device or the external audio device, in response to the first sound being output from the electronic device via the external audio device.

The first control signal may be generated based on the electronic device receiving a call signal.

The instructions, when executed by the at least one processor, may cause the display device to, based on operating in the second mode, the output of the first sound being stopped in response to the first control signal, and the first sound being muted, in response to receiving a second control signal indicating a request to output the first sound via the external audio device, control the display to display the first image and control the communication interface to output the first sound via the external audio device.

The second control signal may be generated from at least one of the electronic device or the external audio device.

The content may include a plurality of items of subcontent, and the instructions, when executed by the at least one processor, may cause the display device to, based on operating in the second mode, in response to receiving a selection signal indicating a selection of at least one item of subcontent from among the plurality of items, identify the at least one item, based on the selection signal, control the display to display a second image corresponding to the plurality of items, and output a first sub-sound corresponding to the at least one item via the external audio device, control the communication interface to stop outputting a second sub-sound corresponding to one or more remaining items of subcontent from among the plurality of items, and mute the second sub-sound.

The instructions, when executed by the at least one processor, may cause the display device to, based on the selection signal and the first control signal being received control the display to continue displaying the second image, stop outputting the first sub-sound via the external audio device, and mute the first sub-sound.

The content may include a plurality of items of subcontent, and the instructions, when executed by the at least one processor, may cause the display device to, based on receiving an operation signal indicating that a plurality of users use the display device and the display device being connected, via the communication interface, to a sub audio device of at least one user from among the plurality of users operate in a third mode that controls the display to display a second image corresponding to the plurality of items, controls the communication interface to output, via the sub audio device, a second sound corresponding to the plurality of items, and controls the audio device to output the second sound.

The instructions, when executed by the at least one processor, may cause the display device to, based on operating in the third mode and the at least one user receiving a selection signal indicating selection of at least one item of subcontent from among the plurality of items, identify the at least one item, based on the selection signal; control the display to display a third image included in the plurality of items; and control the communication interface to output, via the sub audio device, a first sub-sound corresponding to the at least one item, and control the audio device to output a second sub-sound corresponding to one or more remaining items of subcontent from among the plurality of items.

The instructions, when executed by the at least one processor, may cause the display device to, based on the selection signal and the first control signal being received control the display to display the second image, control the communication interface to stop outputting the first sub-sound via the sub audio device, and mute the first sub-sound.

According to an aspect of the disclosure, an operation method of a display device for providing content includes determining whether the display device and an external audio device are connected via a communication interface; based on the display device not being connected to the external audio device, operating in a first mode that controls the display device to display a first image corresponding to the content and controls an audio device to output a first sound corresponding to the content; based on the display device being connected to the external audio device, operating in a second mode that controls the display device to display the first image and controls the communication interface to output the first sound to the external audio device; and based on operating in the second mode, in response to receiving a first control signal indicating a request to stop outputting the first sound via the external audio device, controlling the display device to display the first image, controlling the communication interface to stop outputting the first sound via the external audio device, and muting the first sound.

The operation first control signal may be generated from at least one of an electronic device connected to the external audio device or the external audio device, in response to the first sound being output from the electronic device via the external audio device.

The operation method may further include, based on operating in the second mode, the first sound output being stopped in response to the first control signal, and the first sound being muted, in response to receiving a second control signal indicating a request to output the first sound via the external audio device, controlling the display device to display the first image and controlling the communication interface to output the first sound via the external audio device.

The operation second control signal may be generated from at least one of the electronic device or the external audio device.

According to an aspect of the disclosure, a non-transitory computer-readable recording medium having instructions recorded thereon, which, when executed by at least one processor, cause the at least one processor to determine whether a display device and an external audio device are connected via a communication interface; based on the display device not being connected to the external audio device, control the display device to operate in a first mode that controls the display device to display a first image corresponding to content and controls an audio device of the display device to output a first sound corresponding to the content; based on the display device being connected to the external audio device, operate the display device in a second mode including that controls the display device to display the first image and controls the communication interface to output the first sound via the external audio device; and based on the display device operating in the second mode, in response to receiving a first control signal indicating a request to stop outputting the first sound via the external audio device, control the display device to display the first image, control the communication interface to stop outputting the first sound via the external audio device, and mute the first sound.

### BRIEF DESCRIPTION OF THE DRAWINGS

The above and other aspects, features, and advantages of certain embodiments are more apparent from the following description taken in conjunction with the accompanying drawings, in which:

FIG. 1 is a view illustrating a display device according to an embodiment.

FIG. 2 is a block diagram of the display device according to an embodiment.

FIG. 3 is a flowchart of an operation of the display device according to an embodiment in a first mode and a second mode.

FIG. 4 is a flowchart of an operation of the display device in the second mode according to an embodiment.

FIG. 5 is a flowchart of an operation of a system between a display device, an external audio device, and an electronic device, according to an embodiment.

FIG. 6 is a flowchart of an operation of a display device according to whether a selection signal is obtained, according to an embodiment.

FIG. 7 is a diagram illustrating an operation, performed by a display device according to an embodiment, of providing sound through an external audio device.

FIG. 8 is a diagram illustrating an operation, performed by a display device according to an embodiment, of providing sound corresponding to content selected according to a selection signal, through an external audio device.

FIG. 9 is a flowchart of an operation of a display device according to whether a first control signal requesting termination of sound provision has been obtained after obtainment of a selection signal, according to an embodiment.

FIG. 10 is a view illustrating an operation of a display device when the first control signal requesting termination of sound provision has been obtained after obtainment of a selection signal, according to an embodiment.

FIG. 11 is a flowchart of an operation, in a third mode, of a display device according to whether an operation signal has been obtained, according to an embodiment.

FIG. 12 is a view illustrating an operation of a display device in a third mode according to an embodiment.

FIG. 13 is a flowchart of an operation of a display device according to whether a selection signal is obtained, in a third mode, according to an embodiment.

FIG. 14 is a view illustrating an operation of a display device when a selection signal has been obtained, in a third mode, according to an embodiment.

FIG. 15 is a view illustrating an operation of a display device when the first control signal has been obtained, after obtainment of an operation signal and a selection signal, according to an embodiment.

FIG. 16 is a view illustrating an operation of a display device when a second control signal has been obtained, after obtainment of an operation signal, a selection signal, and a first control signal, according to an embodiment.

### DETAILED DESCRIPTION

The terms used will be described, and then the present disclosure will be described in detail.

Although terms widely used at present were selected for describing the present disclosure in consideration of the functions thereof, these terms may vary according to intentions of one of ordinary skill in the art, case precedents, the advent of new technologies, and the like. Terms arbitrarily selected may also be used. Their meanings may be given in the detailed description. Hence, the terms must be defined based on their meanings and the contents of the entire disclosure, not by simply stating the terms.

An expression used in the singular may encompass the expression of the plural, unless it has a clearly different meaning in the context. Unless otherwise defined, all terms (including technical and scientific terms) used herein have the same meaning as commonly understood by one of ordinary skill in the art to which this disclosure belongs.

The terms “comprises” and/or “comprising” or “includes” and/or “including” used herein specify the presence of stated elements, but do not preclude the presence or addition of one or more other elements. The terms “unit”, “-er (-or)”, and “module,” when used, refers to a unit in which at least one function or operation is performed, and may be implemented as hardware, software, or a combination of hardware and software.

The expression “configured to (or set to)” used therein may be used interchangeably with, for example, “suitable for”, “having the capacity to”, “designed to”, “adapted to”, “made to”, or “capable of”, according to situations. The expression “configured to (or set to)” may not only necessarily refer to “specifically designed to” in terms of hardware. Instead, in some situations, the expression “system configured to” may refer to a situation in which the system is “capable of” together with another device or parts. For example, the phrase “a processor configured (or set) to perform A, B, and C” may mean a dedicated processor (such as an embedded processor) for performing a corresponding operation, or a processor, such as a central processing unit (CPU) or an application processor (AP), that can perform a corresponding operation by executing one or more software programs stored in a memory.

When an element (e.g., a first element) is “coupled to” or “connected to” another element (e.g., a second element), the first element may be directly coupled to or connected to the second element, or, unless otherwise described, a third element may exist therebetween.

The expressions “at least one of A, B and C” and “at least one of A, B, or C”, both indicate “A”, only “B”, only “C”, both “A and B”, both “A and C”, both “B and C”, and all of “A, B, and C”.

Embodiments are described in detail herein with reference to the accompanying drawings so that this disclosure may be performed by one of ordinary skill in the art to which the disclosure pertains. Embodiments may be embodied in many different forms and should not be construed as being limited to the embodiments set forth herein. In the drawings, like numbers refer to like elements throughout.

Embodiments now will be described more fully hereinafter with reference to the accompanying drawings.

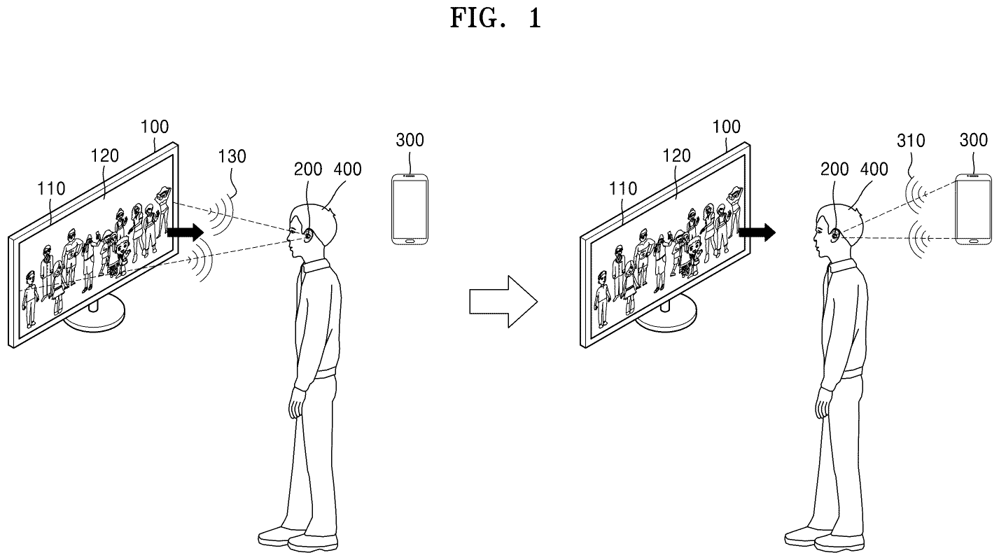

FIG. 1 is a view illustrating a display device according to an embodiment.

Referring to FIG. 1, according to an embodiment, a display device 100 may be a display device that provides content to a user 400. According to an embodiment, the content may include an image 120 and sound 130. The display device 100 may include a display 110 and an audio device (e.g., speaker). The display device 100 may display the image 120 corresponding to the content via the display 110. The display device 100 may provide the user 400 with the image 120 corresponding to the content via the display 110. The display device 100 may output the sound 130 corresponding to the content via the audio device. The display device 100 may provide the user 400 with the sound 130 corresponding to the content via the audio device.

According to an embodiment, referring to FIG. 1, the display device 100 is illustrated as a television that provides content. However, the disclosure is not limited thereto. The display device 100 may be implemented as any of various shapes of display devices, such as a digital signage, a projector, a mobile device, a smartphone, a laptop computer, a desktop, a tablet PC, and a wearable device. For convenience of explanation, the display device 1100 will now be described as a television that provides content.

According to an embodiment, the user 400 may view content by receiving the image 120 through the display 110 included in the display device 100 and receiving the sound 130 from an audio device included in the display device 100.

According to an embodiment, the display device 100 may be connected to an external audio device (e.g., external audio source) 200. The external audio device 200, which is a component located outside the display device 100, may be a device located around the display device 100. According to an embodiment, the external audio device 200 may include a wireless earphone, a wireless headphone, or a wireless speaker, for example. According to an embodiment, the display device 100 may be connected to the external audio device 200 through a communication interface. The display device 100 may perform data communication with the external audio device 200 by using a Bluetooth method, through a communication interface. For convenience of explanation, the external audio device 200 will now be described as being a wireless earphone connected to the display device 100 by using Bluetooth.

According to an embodiment, based on the display device 100 being connected to the external audio device 200, the display device 100 may display the image 120 through the display 110 and provide the sound 130 to the external audio device 200. According to an embodiment, the display device 100 may provide the sound 130 to the external audio device 200 without outputting the sound 130 to the audio device included in the display device 100. The user 400 currently wearing the external audio device 200 may receive the sound 130 provided by the display device 100 through the external audio device 200.

According to an embodiment, when the display device 100 outputs the sound 130 through the audio device included in the display device 100, the sound 130 may be provided to not only the user 400 but also other users located around the display device 100. In contrast, when the display device 100 provides the sound 130 through the external audio device 200, the sound 130 may be provided only to the user 400 currently wearing the external audio device 200.

According to an embodiment, because the display device 100 provides the sound 130 through the external audio device 200, provision of the sound 130 to other users not using the display device 100 may be prevented. Accordingly, unnecessary noise may be prevented from being generated by the display device 100. The user 400 may use the external audio device 200 to view content by using the display device 100 without worrying about noise being generated in the surroundings. Moreover, the user 400 may use the external audio device 200 to receive sound of the content 130 being viewed, and may use the display device 100 so that the sound 130 of the content is not provided to the surroundings. Accordingly, the privacy of the user 400 may be protected.

According to an embodiment, the external audio device 200 may also be connected to an electronic device (e.g., user terminal) 300 in addition to the display device 100. According to an embodiment, the electronic device 300 may provide the sound 310 to the external audio device 200. The user 400 may receive the sound 310 provided by the electronic device 300, through the external audio device 200. According to an embodiment, the electronic device 300 may be implemented as various types of electronic devices, such as a mobile device, a smartphone, a tablet PC, and a wearable device. According to an embodiment, the electronic device 300 may be an electronic device that receives a call signal and provides a call function to the user 400 using the electronic device 300. For convenience of explanation, the electronic device 300 will now be described as being a smartphone.

According to an embodiment, the display device 100 and the electronic device 300 may be logged in with the same user's account. According to an embodiment, the electronic device 300 may be a smartphone logged in with an account of the user 400, and the display device 100 may also be logged in with the account of the user 400 who uses the display device 100. However, the disclosure is not limited thereto. The display device 100 and the electronic device 300 may include devices that have a history of being connected to the same external audio device 200. The external audio device 200 may store a history of connection to the display device 100 and a history of connection to the electronic device 300.

According to an embodiment, while the sound 130 of the content is being provided to the user 400 through the external audio device 200, an event may occur that sound is provided from the electronic device 300 connected to the external audio device 200 to the external audio device 200. According to an embodiment, the event of providing the sound to the external audio device 200 refers to an event in which the electronic device 300 provides sound to the external audio device 200 to thereby provide the sound of the electronic device 300 to the user 400.

According to an embodiment, the type of event of providing sound may be pre-set by the electronic device 300. According to an embodiment, the event of providing sound may be pre-set as an alarm, a call, or a message, for example. For convenience of explanation, the event of providing sound will now be described as a case where a call comes in to the electronic device 300 and thus the electronic device 300 receives a call signal.

According to an embodiment, in response to a call signal, the electronic device 300 may generate a termination request signal requesting termination of connection with the display device 100 and provide the termination request signal to the external audio device 200. In response to a call signal, the electronic device 300 may generate a first control signal of requesting termination of provision of the sound 130 to the external audio device 200 and provide the first control signal to the display device 100 logged in with the same user account.

According to an embodiment, the external audio device 200 that has obtained the termination request signal may terminate the connection with the display device 100. Moreover, the display device 100 that has obtained the first control signal may stop providing the sound 130 to the external audio device 200, and may mute the sound 130.

However, the disclosure is not limited thereto. The electronic device 300 may generate a termination request signal requesting termination of connection with the external audio device 200 and provide the termination request signal to the display device 100. The display device 100 that has obtained the termination request signal may terminate the connection with the external audio device 200, stop providing the sound 130 to the external audio device 200, and mute the sound 130.

According to an embodiment, based on the connection with the external audio device 200 being terminated, the display device 100 may mute the sound 130 of the content. Even based on the connection with the external audio device 200 being terminated, the display device 100 may continuously display the image 120 through the display 110.

According to an embodiment, when the user 400 who is using the display device 100 by wearing the external audio device 200 has a call through the electronic device 300 to which his/her user account has been logged in, the user 400 may receive the sound 310 from the electronic device 300 through the external audio device 200. However, the disclosure is not limited thereto, and the user 400 may also transmit voice to the electronic device 300 through the external audio device 200.

The sound 130 of the content received by the user 400 through the external audio device 200 may be muted, and thus generation of unnecessary noise in the surroundings by the display device 100 may be prevented. Because the sound 130 of the content being watched by the user 400 is not provided to the surroundings, privacy of the user 400 may be protected.

Moreover, even when the sound 130 of the content is muted, the image 120 of the content is continuously displayed through the display 110. Accordingly, the user 400 may continue to watch the image 120 of the content that he or she has been already watched while making a call by using the external audio device 200 and the electronic device 300, the continuity of the user 400's experience may be maintained.

However, the disclosure is not limited thereto. Based on connection of the display device 100 to the external audio device 200 being terminated, the display device 100 may stop displaying the image 120 of the content through the display 110, and may stop providing the sound 130 of the content through the external audio device 200. While the user 400 is using the electronic device 300 through the external audio device 200, provision of the content by the display device 100 may be stopped. After using the electronic device 300, the user 400 may continue watching the interrupted content, thereby increasing the convenience of the user 400.

According to an embodiment, in response to a termination signal indicating that a call has been terminated, the electronic device 300 may generate a second control signal indicating that use of the external audio device 100 has been terminated, and provide the second control signal to the display device 100. According to an embodiment, the display device 100 that has obtained the second control signal may generate a termination request signal requesting termination of connection with the electronic device 300, and provide the termination request signal to the external audio device 200. The display device 100 may provide a connection request signal to the external audio device 200 disconnected from the electronic device 300, and the display device 100 and the external audio device 200 may be reconnected to each other.

The display device 100 may again provide the sound 130 of the content to the user 400 through the external audio device 200. Accordingly, the user 400 may continuously receive the image 120 of the content through the display device 100, and may receive the sound 130 of the content before and after using the electronic device 300.

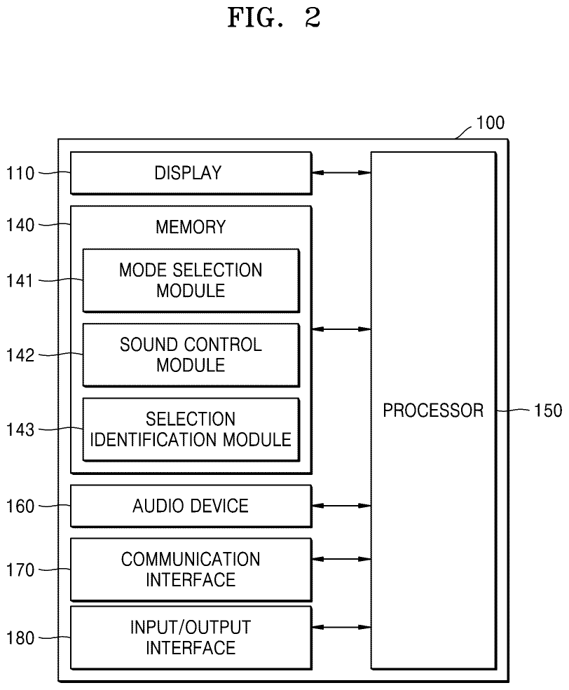

FIG. 2 is a block diagram of the display device 100 according to an embodiment.

Referring to FIGS. 1 and 2, according to an embodiment, the display device 100 may include the display 110, a memory 140, at least one processor 150, an audio device 160, a communication interface 170, and an input/output interface 180. According to an embodiment, not all of the components illustrated in FIG. 2 are essential components. The display device 100 may be implemented by more or less components than those illustrated in FIG. 2.

According to an embodiment, the display 110, the memory 140, the at least one processor 150, the audio device 160, the communication interface 170, and the input/output interface 180 may be electrically and/or physically connected to each other.

The same configuration as that described above with reference to FIG. 1 is given the same reference numerals, and reference may be made to the descriptions of FIG. 1 for additional implementation details.

According to an embodiment, the display 110 may include any one of a liquid crystal display, a plasma display, an organic light-emitting diode display, and an inorganic light-emitting diode display. However, the disclosure is not limited thereto, and the display 110 may include another type of display capable of providing the image 120 of the content to a user.

According to an embodiment, the memory 140 may include at least one of a flash memory type memory, a hard disk type memory, a multimedia card micro type memory, a card type memory (for example, a secure digital (SD) or extreme digital (XD) memory), a random access memory (RAM), a static random access memory (SRAM), a read-only memory (ROM), an electrically erasable programmable ROM (EEPROM), a programmable ROM (PROM), a mask ROM, a flash ROM, a hard disk drive (HDD), or a solid state drive (SSD). Instructions or program code for performing functions or operations of the display device 100 may be stored in the memory 140. The instructions, algorithm, data structure, program code, and application programs stored in the memory 140 may be implemented in, for example, programming or scripting languages such as C, C++, Java, assembler, and the like.

According to an embodiment, the memory 140 may store various types of modules that may be used to provide content through the display device 100. The memory 140 may store various types of modules that may be used to provide the sound 130 of the content through the external audio device 200 or to mute the sound 130 of the content when operating the display device 100.

According to an embodiment, the memory 140 may store a mode selection module 141, a sound control module 142, and a selection identification module 143. The memory 140 may store more or less modules than those illustrated in FIG. 2.

A ‘module’ included in the memory 140 may refer to a unit that processes a function or operation performed by the at least one processor 150. The ‘module’ included in the memory 140 may be implemented as software such as instructions, an algorithm, a data structure, or program code.

According to an embodiment, the mode selection module 141 may be configured with instructions or program code relating to an operation or function of selecting whether the display device 100 operates in a first mode of outputting the sound 130 of the content through the audio device 160 or in a second mode of providing the sound 130 of the content through the external audio device 200.

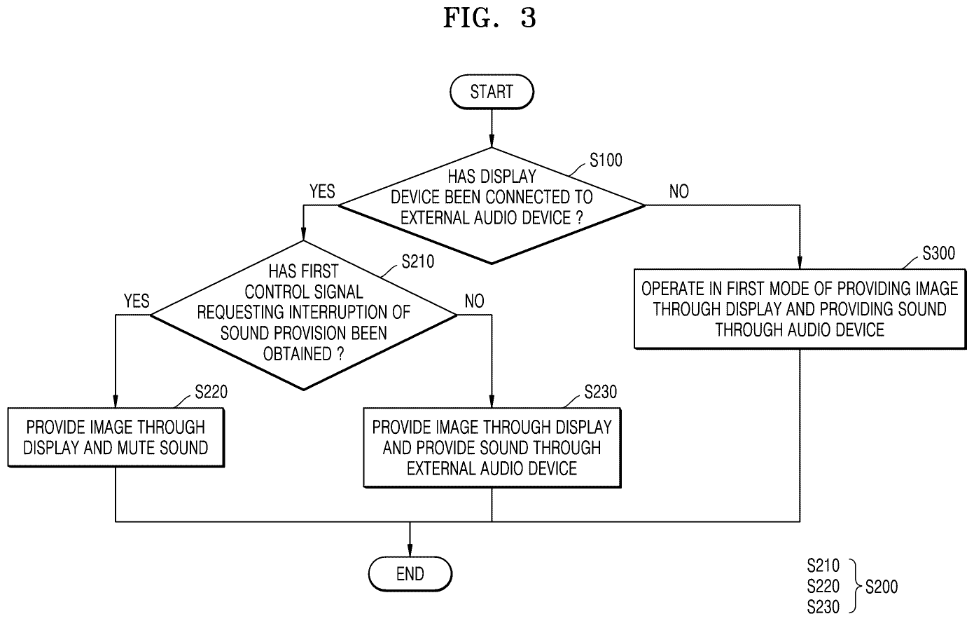

According to an embodiment, the at least one processor 150 may select an operation of the first mode or the second mode of the display device 100 by executing the mode selection module 141. According to an embodiment, when the at least one processor 150 executes the mode selection module 141, the display device 100 may operate in the second mode when the display device 100 is connected to the external audio device 200 through the communication interface 170. When the at least one processor 150 executes the mode selection module 141, the display device 100 may operate in the first mode when the display device 100 is not connected to the external audio device 200. The first mode and the second mode will now be described later in the descriptions of FIGS. 3 through 11.

According to an embodiment, the mode selection module 141 may further include instructions or program code relating to an operation or function of selecting whether the display device 100 operates in a third mode of providing the sound 130 of the content to at least one of a plurality of users through the external audio device 200 and outputting the sound 130 of the content to the remaining users through the audio device 160.

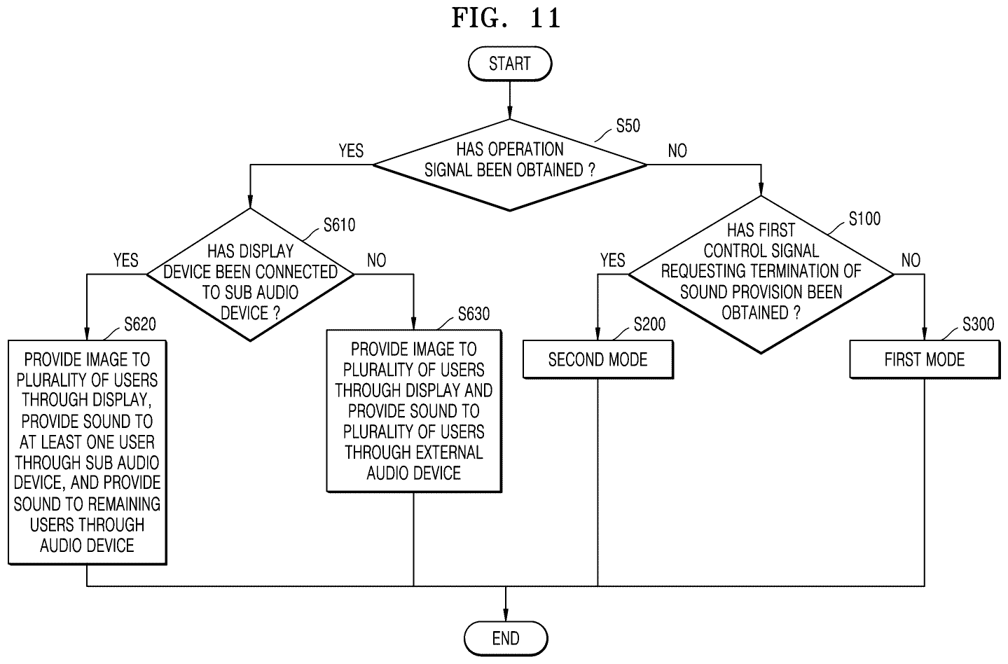

According to an embodiment, when the at least one processor 150 executes the mode selection module 141, the display device 100 may select an operation of one of the first mode, the second mode, or the third mode. According to an embodiment, when the at least one processor 150 executes the mode selection module 141, the display device 100 may obtain an operation signal including information indicating that the plurality of users use the display device 100, and, based on the display device 100 being connected to an external audio device of at least one user among the plurality of users through a communication interface, may operate in the third mode. The third mode will now be described later in the descriptions of FIGS. 11 through 16.

According to an embodiment, the sound control module 142 may be configured with instructions or program code relating to an operation or function of muting the sound of content provided by the display device 100.

According to an embodiment, when the at least one processor 150 executes the sound control module 142, the display device 100 may mute the sound provided by the display device 100, based on the display device 100 obtaining a first control signal requesting interruption of sound provision through the external audio device 200.

According to an embodiment, the sound control module 142 may be configured with instructions or program code relating to an operation or function of unmuting the muted sound of the content provided by the display device 100. According to an embodiment, when the at least one processor 150 executes the sound control module 142, the display device 100 may again unmute the muted sound provided by the display device 100, based on the display device 100 obtaining a second control signal requesting sound provision through the external audio device 200.

According to an embodiment, the content may include a plurality of items of subcontent. The selection identification module 143 may be configured with instructions or program code related to an operation or function of identifying at least one item of subcontent among a plurality of items of subcontent, based on a selection signal including information indicating selection of at least one item of subcontent from among the plurality of items of subcontent.

According to an embodiment, the at least one processor 150 may obtain a selection signal including information indicating that the user 400 has selected at least one item of subcontent from among the plurality of items of subcontent provided by the display device 100. According to an embodiment, the selection signal may be a signal generated by an action of the user 400 touching the display 110 of the display device 100, or generated by an action of the user 400 selecting at least one item of subcontent from among the plurality of items of subcontent through another external electronic device.

According to an embodiment, the user 400 may select at least one item of the plurality of items of subcontent by using an external electronic device in the form of a remote controller. The user 400 may photograph at least one item of subcontent from among the plurality of items of subcontent by using the electronic device 300, thereby capturing at least one item of subcontent. An external electronic device or the electronic device 300 may generate a selection signal including information such as coordinate information, image information, or area of the selected at least one item of subcontent, and may provide the generated selection signal to the display device 100.

According to an embodiment, the at least one processor 150 may execute the selection identification module 143 to identify at least one item of subcontent from among the plurality of items of subcontent, based on the selection signal. The at least one processor 150 may execute the selection identification module 143 to identify the at least one item of subcontent selected by the user 400, based on the coordinate information of the selected at least one item of subcontent within the display 110. The at least one processor 150 may also execute the selection identification module 143 to extract a feature of image information included in the selection signal, and compare the extracted feature with a feature of the content provided through the display 110 to identify the at least one item of subcontent selected by the user 400.

According to an embodiment, the at least one processor 150 may include, but are not limited to, at least one of a central processing unit, a microprocessor, a graphics processing unit, an application processor (AP), application specific integrated circuits (ASICs), digital signal processors (DSPs), digital signal processing devices (DSPDs), programmable logic devices (PLDs), field programmable gate arrays (FPGAs), a neural processing unit, or an artificial intelligence (AI) dedicated processor designed with a hardware structure specialized for processing an AI model.

According to an embodiment, the at least one processor 150 may execute various types of modules stored in the memory 140. According to an embodiment, the at least one processor 150 may execute the mode selection module 141, the sound control module 142, and the selection identification module 143 stored in the memory 140. According to an embodiment, the at least one processor 150 may execute at least one instruction that constitutes the various types of modules stored in the memory 140.

According to an embodiment, the communication interface 170 may perform data communication with an external server under a control by the at least one processor 150. The communication interface 170 may perform data communication with not only the external server but also other external electronic devices. The communication interface 170 may be connected to the external audio device 200 and the electronic device 300 to perform data communication. According to an embodiment, the at least one processor 150 may control the communication interface 170 to provide sound of the content to the external audio device 200.

According to an embodiment, the communication interface 170 may perform data communication with a server, other electronic devices, the external audio device 200, or the electronic device 300 by using at least one of data communication methods including, for example, a wired LAN, a wireless LAN, Wi-Fi, Bluetooth, Zigbee, Wi-Fi Direct (WFD), infrared communication (IrDA), Bluetooth Low Energy (BLE), Near Field Communication (NFC), Wireless Broadband Internet (Wibro), World Interoperability for Microwave Access (WiMAX), a shared wireless access protocol (SWAP), Wireless Gigabit Alliance (WiGig), and RF communication.

According to an embodiment, the input/output interface 180 may perform an operation of inputting/outputting image data to/from the external server or the other electronic devices, under a control by the at least one processor 150. According to an embodiment, the at least one processor 150 may receive the content from the external server or the other electronic devices via the input/output interface 180. According to an embodiment, the input/output interface 180 may perform an operation of inputting/outputting the content to/from the external server or the other external electronic devices by using at least one of input/output methods including a High-Definition Multimedia Interface (HDMI), a Digital Visual Interface (DVI), and a Universal Serial Bus (USB). However, the disclosure is not limited to the aforementioned input/output methods.

FIG. 3 is a flowchart of an operation of the display device according to an embodiment in the first mode and the second mode.

Referring to FIGS. 1, 2, and 3, an operation method of the display device 100 may include an operation S100 of determining whether the display device 100 has been connected to the external audio device 200. According to an embodiment, in the operation S100 of determining whether the display device 100 has been connected to the external audio device 200, the at least one processor 150 may determine whether the display device 100 has been connected with the external audio device 200 through the communication interface 170. According to an embodiment, the at least one processor 150 may transmit and receive a connection signal to and from the external audio device 200 via the communication interface 170 to determine whether the display device 100 has been connected with the external audio device 200. According to an embodiment, the connection signal may utilize a Bluetooth method.

According to an embodiment, the operation method of the display device 100 may include an operation S200 of, when the display device 100 has been connected with the external audio device 200, operating in a second mode of controlling the display 110 to display the image 120 of the content and controlling the communication interface 170 to provide the sound 130 of the content to the external audio device 200. In an operation of operating in the second mode, the at least one processor 150 may control the communication interface 170 to provide the image 120 of the content to the user 400 by displaying the image 120 through the display 110 and provide the sound 130 of the content to the external audio device 200. The at least one processor 150 may provide the sound 130 of the content to the user 400 via the external audio device 200.

According to an embodiment, in the operation S200 of operating in the second mode while the display device 100 is connected to the external audio device 200, the operation method of the display device 100 may include an operation S210 of determining whether the first control signal requesting interruption of sound provision has been obtained.

According to an embodiment, the operation method of the display device 100 may include an operation S220 of, when the first control signal has been obtained, controlling the display 110 to display the image 120 of the content, controlling the communication interface 170 to stop providing the sound 130 of the content to the external audio device 200, and muting the sound 130 of the content. According to an embodiment, the at least one processor 150 may display the image 120 of the content through the display 110, when the first control signal is obtained. The at least one processor 150 may provide the image 120 of the content to the user 400 via the display 110. According to an embodiment, when the first control signal has been obtained, the at least one processor 150 may control the communication interface 170 to stop providing the sound 130 of the content to the external audio device 200, and may mute the sound 130 of the content. When the first control signal has been obtained, the at least one processor 150 may mute the sound 130 of the content provided to the user 400.

According to an embodiment, the operation method of the display device 100 may include an operation S230 of, when the first control signal has not been obtained, controlling the display 110 to display the image 120 of the content and controlling the communication interface to provide the sound 130 of the content to the external audio device 200. According to an embodiment, when it is determined that the at least one processor 150 is connected to the external audio device, but the first control signal has not been obtained, the at least one processor 150 may provide the image 120 of the content to the user 400 by displaying the image 120 of the content through the display 110, and provide the sound 130 of the content to the user 400 through the external audio device 200.

According to an embodiment, the operation method of the display device 100 may include an operation S300 of, based on the display device 100 having not been connected with the external audio device 200, operating in a first mode of controlling the display 110 to provide the image 120 of the content and controlling the audio device 160 to output the sound 130 of the content. In the operation S300 of operating in the first mode, the at least one processor 150 may operate in a first mode of displaying the image 120 of the content through the display 110 to provide the image 120 to the user 400 and outputting the sound 130 of the content through the audio device 160 to provide the sound 130 to the user 400.

However, the disclosure is not limited thereto. The operation method of the display device 200 may further include an operation of controlling the display 110 to provide the image 120 of the content and controlling the audio device 160 to output the sound 130 of the content, before the operation S100 of determining whether the display device 100 has been connected with the external audio device 200. The at least one processor 150 may determine whether the display device 100 has been connected with the external audio device 200, while providing the image 120 and the sound 130 of the content to the user 400 through the display 110 and the audio device 160.

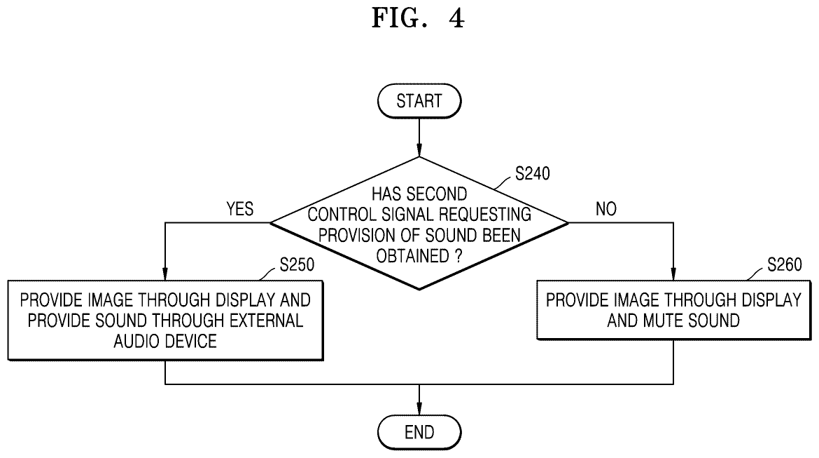

FIG. 4 is a flowchart of an operation of a display device in the second mode according to an embodiment. The same operations as those described above with reference to FIG. 3 are given the same reference numerals, and reference may be made to the descriptions of FIG. 3 for additional implementation details.

Referring to FIGS. 1, 2, 3, and 4, the operation method of the display device 100 may further include an operation S240 of determining whether the second control signal requesting provision of sound through the external audio device 200 has been obtained, after the operation S220 of muting sound in response to obtainment of the first control signal in the operation of operating in the second mode.

According to an embodiment, the operation method of the display device 100 may further include an operation S250 of, based on the second control signal having been obtained, controlling the display 110 to display the image 120 of the content and controlling the communication interface 170 to provide the sound 130 of the content to the external audio device 200. According to an embodiment, based on the second control signal having been obtained, the at least one processor 150 may provide the image 120 of the content to the user 400 by displaying the image 120 through the display 110, and unmute the muted sound 130 and provide a result of the unmuting to the user 400 through the external audio device 200.

According to an embodiment, the operation method of the display device 100 may further include an operation S260 of, based on the second control signal having not been obtained, controlling the display 110 to display the image 120 of the content and maintaining sound in a mute state. According to an embodiment, when the second control signal is not obtained, the at least one processor 150 may maintain the image 120 of the content provided to the user 400 through the display 110, and may maintain the sound 130 of the content in a muted state.

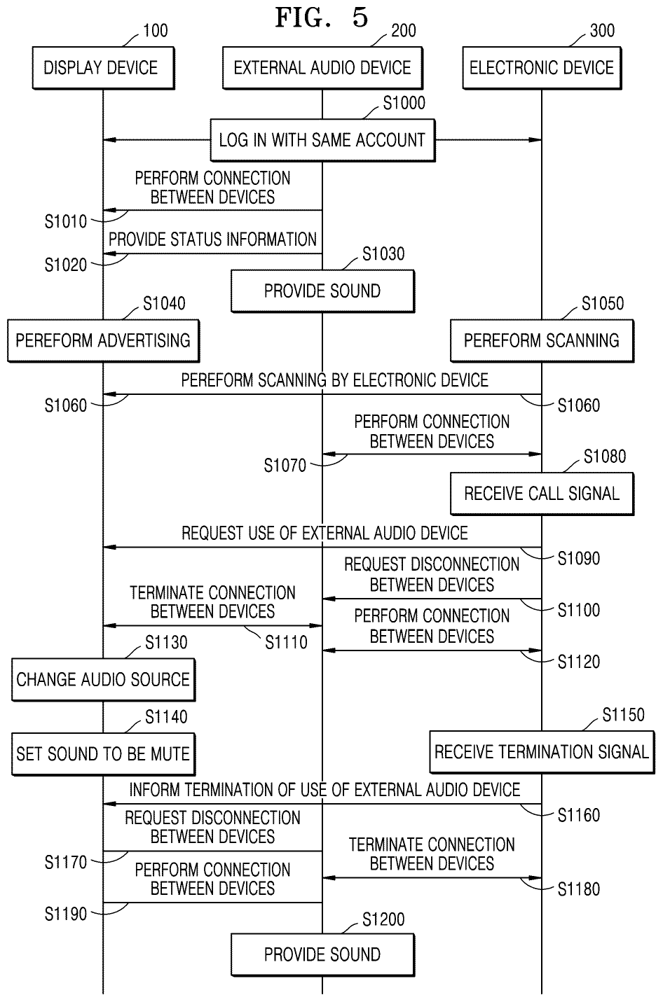

FIG. 5 is a flowchart of an operation of a system between a display device, an external audio device, and an electronic device according to an embodiment.

Referring to FIGS. 1, 2, and 5, according to an embodiment, a system for providing content to the user 400 may include at least the display device 100, the external audio device 200, and the electronic device 300 located in the surroundings.

According to an embodiment, the display device 100 may provide the content to the user 400. The user 400 may obtain the image 120 of the content via the display 110 of the display device 100. The user 400 may connect the external audio device 200 to the display device 100 to obtain the sound 130 of the content provided by the display device 100 through the external audio device 200.

According to an embodiment, while content of the display device 100 is being watched by using the external audio device 200, when a call signal is provided to the electronic device 300 of the user, the user 400 may transmit and receive voice sound including call sound from the electronic device 300 by using the external audio device 200.

According to an embodiment, the display device 100 may mute the sound 130 of the content provided to the user 400, while the external audio device 200 is being used to provide the sound of the electronic device 300 to the user 400. At this time, the display device 100 may continuously provide the image 120 of the content to the user 400 via the display 110.

According to an embodiment, when a termination signal is received by the electronic device 300, the display device 100 may unmute the sound 130 of the content and provide the unmuted sound 130 to the user 400 via the external audio device 200.

An operation of the above-described system will now be described in detail.

According to an embodiment, the operation of the system may include an operation S1000 in which the display device 100 and the electronic device 300 are logged in with the same account. According to an embodiment, the display device 100 and the electronic device 300 may be logged in with the same user's account. Accordingly, when a call signal is provided to the electronic device 300 to be described later, a device use request signal may be provided to the display device 100 logged in with the same account. A signal requesting disconnection from the display device 100 may be provided to the external audio device 200 connected to the display device 100 logged in with the same account.

However, the disclosure is not limited thereto, and the display device 100 and the electronic device 300 may each include a history of being connected to the same external audio device 200. When the external audio device 200 receives a device use request signal from the electronic device 300 having a connection history, the external audio device 200 may provide a disconnection requesting signal to the display device 100 having a connection history, and may also provide a connection request signal to the electronic device 300.

According to an embodiment, the operation of the system may include an operation S1010 in which the display device 100 and the electronic device 300 are connected to each other. According to an embodiment, in the operation S1010 where the display device 100 and the external audio device 200 are connected to each other, the display device 100 and the external audio device 200 may be connected to each other using a Bluetooth method. The display device 100 may be connected to the external audio device 200 through the communication interface 170 by using a Bluetooth method. The system between the display device 100, the external audio device 200, and the electronic device 300 will now be described as being connected to each other by using a Bluetooth method. However, the disclosure is not limited thereto, and the display device 100, the external audio device 200, and the electronic device 300 may be connected to each other by using other methods by which data communication between them may be achieved.

Referring to FIGS. 3 and 5, in the operation S100 of determining whether the display device 100 is connected to the external audio device 200, it may be determined whether the display device 100 has been connected with the external audio device 200.

According to an embodiment, in the operation S1010 where the display device 100 and the external audio device 200 are connected to each other, a Serial Port Profile (SPP) of Bluetooth and a Hands-Free Profile (HFP) of Bluetooth may be connected between the display device 100 and the external audio device 200. However, the disclosure is not limited thereto, and the SPP of Bluetooth, the HFP of Bluetooth, and an Advanced Audio Distribution Profile (A2DP) of Bluetooth may be connected between the display device 100 and the external audio device 200. For convenience of explanation, it will now be described that the HFP of Bluetooth and the A2DP of Bluetooth are connected between the display device 100 and the external audio device 200.

According to an embodiment, the operation of the system may include an operation S1020 in which the external audio device 200 provides status information to the display device 100. According to an embodiment, in operation S1020 of providing the status information, the external audio device 200 may provide, to the display device 100, status information including information about whether the user 400 uses the external audio device 200. According to an embodiment, the status information of the external audio device 200 may be provided to the display device 100 by using the SPP of Bluetooth.

According to an embodiment, the external audio device 200 may include a temperature sensor, a touch sensor, or the like to determine whether the user 400 has worn the external audio device 200 on his or her ear, thereby determining whether the external audio device 200 is used. According to an embodiment, the display device 100 may update status information of the external audio device 200, based on the received status information. The status information may include, for example, whether the user 400 has worn the external audio device 200.

According to an embodiment, the operation of the system may include an operation S1030 in which the display device 100 provides the sound 130 of the content to the user 400 by using the external audio device 200. According to an embodiment, when it is determined that the user 400 has worn the external audio device 200, based on the received status information, in the operation S1030 of providing the sound 130 of the content, the display device 100 may provide the sound 130 of the content to the user 400 through the external audio device 200.

According to an embodiment, the display device 100 may provide the sound 130 of the content to the external audio device 200 by using the SPP and A2DP of Bluetooth.

According to an embodiment, the operation of the system may include an operation S1040 in which the display device 100 broadcasts an advertising signal for the external audio device 200. According to an embodiment, in the operation S1040 of broadcasting the advertising signal, the display device 100 may broadcast an advertising signal including connection or non-connection with the external audio device 200 and status information of the external audio device 200.

According to an embodiment, the operation of the system may include an operation S1050 in which the display device 300 scans a connectable Bluetooth-type device.

According to an embodiment, the operation of the system may include an operation S1060 in which the electronic device 300 scans an advertising signal from the display device 100. The electronic device 300 may obtain the connection or non-connection between the display device 100 and the external audio device 200, the status information of the external audio device 200, and the like, based on the scanned advertising signal.

According to an embodiment, the operation of the system may include an operation S1070 in which the electronic device 300 and the external audio device 200 are connected to each other. In the operation S1070 in which the electronic device 300 and the external audio device 200 are connected to each other, the electronic device 300 may request, for a connection to the electronic device 300, the external audio device 200 connected to the display device 100 logged in to the same user account, based on the scanned advertising signal.

According to an embodiment, in the operation S1070 in which the electronic device 300 and the external audio device 200 are connected to each other, the SPP of Bluetooth may be connected between the electronic device 300 and the external audio device 200. The electronic device 300 may provide a connection request signal, or a connection termination signal, for example, to the external audio device 200 by using the SPP of Bluetooth. At this time, the HFP and A2DP of Bluetooth may not be connected between the electronic device 300 and the external audio device 200, and thus the sound provided by the electronic device 300 may not be transmitted to the external audio device 200.

However, the disclosure is not limited thereto. When the electronic device 300 is first connected to the external audio device 200, the electronic device 300 may broadcast an advertising signal including the connection or non-connection with the external audio device 200 and the status information of the external audio device 200. The display device 100 may scan the advertising signal, and may request the external audio device 200 for connection to the display device 100, based on the scanned advertising signal. An operation in which the display device 100 scans the advertising signal and an operation of requesting the external audio device 200 for a connection to the display device 100 may be performed in the operation S1030 of providing sound.

According to an embodiment, the operation of the system may include an operation S1080 in which the electronic device 300 receives a call signal. According to an embodiment, the call signal may be a signal provided from a communication server to the electronic device 300 when a call comes into the electronic device 300. According to an embodiment, when the electronic device 300 is logged in with the account of the user 400, the call signal may be a signal provided to the electronic device 300 to provide information indicating that a call is coming from the communication server to call the user 400.

According to an embodiment, the operation of the system may include an operation S1090 in which the electronic device 300 provides a signal requesting use of the external audio device 200 to the display device 100. According to an embodiment, when the electronic device 300 receives the call signal, the electronic device 300 may provide the signal requesting use of the external audio device 200 to the display device 100 currently being logged in with the same user account. According to an embodiment, when the electronic device 300 and the display device 100 are currently being logged in with the same user account, the electronic device 300 may provide the signal requesting use of the external audio device 200 to the display device 100 through a cloud server.

According to an embodiment, the electronic device 300 may provide the signal requesting the use of the external audio device 200 to the display device 100 that has a history of connection to the external audio device 200. At this time, the display device 100 and the electronic device 300 may be connected via the SPP of Bluetooth, and may provide the signal requesting the use of the external audio device 200 by using the SPP.

Referring to FIGS. 3 and 5, in the operation S210 of determining whether the first control signal requesting to stop providing sound has been obtained, it may be determined whether the display device 100 has received the signal requesting the use of the external audio device 200 from the electronic device 300. The first control signal requesting to stop providing sound may be a signal corresponding to a signal through which the electronic device 300 receives a call signal and requests the use of the external audio device 200 to achieve a call.

According to an embodiment, the operation of the system may include an operation S1100 in which the electronic device 300 provides a signal requesting the external audio device 200 for disconnection between the display device 100 and the external audio device 200. According to an embodiment, the electronic device 300 may provide the signal requesting the external audio device 200 for disconnection from the display device 100, by using the SPP of Bluetooth.

According to an embodiment, the operation of the system may include an operation S1110 of terminating connection between the external audio device 200 and the display device 100. According to an embodiment, when the external audio device 200 receives the signal requesting disconnection from the display device 100 from the electronic device 300, the external audio device 200 may provide the signal requesting disconnection to the display device 100. According to an embodiment, when the display device 100 receives the signal requesting disconnection from the external audio device 200, the display device 100 may terminate connection of the HPP and A2DP of Bluetooth with the external audio device 200. At this time, the connection of the SPP of Bluetooth between the display device 100 and the external audio device 200 may be maintained.

According to an embodiment, the operation of the system may include an operation S1120 in which the external audio device 200 and the electronic device 300 are connected to each other. In the operation S1120 in which the external audio device 200 and the electronic device 300 are connected to each other, the electronic device 300 may provide a connection requesting signal to the external audio device 200 by using the SPP of Bluetooth. The HFP and A2DP of Bluetooth may be connected to the electronic device 300 and the external audio device 200.

According to an embodiment, the electronic device 300 may provide sound of a call to the user 400 through the external audio device 200 by using the HFP and A2DP of Bluetooth. Sound of the user 400 may be received from the user 400 through the external audio device 200.

According to an embodiment, the operation of the system may include an operation S1130 in which the display device 100 changes an audio source. According to an embodiment, the audio source may refer to a source that the display device 100 selects to provide the sound 130 of the content. According to an embodiment, in the operation S1130 of changing the audio source, the display device 100 may change an audio source providing the sound 130 of the content from the external audio device 200 to another audio device. According to an embodiment, when there is a history of another audio device connected to the display device 100 prior to being connected to the external audio device 200, the display device 100 may change the audio source providing the sound 130 of the content to the other audio device connected prior to being connected to the external audio device 200, in the operation S1130 of changing the audio source. According to an embodiment, the other audio device may be the audio device 160 included in the display device 100, or a separate audio device connected to the display device 100 via a Bluetooth, Wireless-fidelity (Wi-Fi), or a High Definition Multimedia Interface (HDMI) cable, for example. For convenience of explanation, the other audio device connected prior to being connected to the external audio device 200 will now be described as being the audio device 160 included in the display device 100.

According to an embodiment, the operation of the system may include an operation S1140 in which the display device 100 mutes the sound 130 of the content. According to an embodiment, the display device 100 may set the sound 130 of the content to be mute, after changing the audio source to the audio device 160 included in the display device 100 in the operation S1130 of changing the audio source. According to an embodiment, the display device 100 may mute the sound 130 of the content by changing sound settings of the audio device 160 to mute. Accordingly, the display device 100 may not provide the sound 130 of the content to the user 400 who has received a phone call sound of the electronic device 300 through the external audio device 200. The display device 100 may provide, through the display 110, the image 120 of the content to the user 400 who has received a phone call sound of the electronic device 300 through the external audio device 200.

Referring to FIGS. 3 and 5, in the operation S220 of controlling the display 110 to display the image 120 of the content and muting the sound 130 of the content, connection between the display device 100 and the external audio device 200 may be terminated, so that the audio source of the display device 100 may be changed and then the sound 130 of the content may be muted.

According to an embodiment, the operation of the system may include an operation S1150 in which the electronic device 300 receives a termination signal. According to an embodiment, the call signal may be a signal provided from a communication server to the electronic device 300 when a call coming into the electronic device 300 is terminated.

According to an embodiment, the operation of the system may include an operation S1160 in which the electronic device 300 provides a signal including information informing termination of the use of the external audio device 200 to the display device 100. According to an embodiment, when the electronic device 300 has received the termination signal, the electronic device 300 may provide the signal including the information informing termination of the use of the external audio device 200, to the display device 100 currently being logged in with the same user account. According to an embodiment, when the electronic device 300 and the display device 100 are currently being logged in with the same user account, the electronic device 300 may provide a signal informing termination of the use of the external audio device 200 to the display device 100 through a cloud server.

According to an embodiment, the electronic device 300 may provide the signal informing termination of the use of the external audio device 200 to the display device 100 that has a history of connection to the external audio device 200. At this time, the display device 100 and the electronic device 300 may be connected via the SPP of Bluetooth, and may provide the signal informing termination of the use of the external audio device 200 by using the SPP.

According to an embodiment, the operation of the system may include an operation S1170 in which the display device 100 provides a signal requesting the external audio device 200 for disconnection from the electronic device 300. According to an embodiment, the display device 100 may provide the signal requesting the external audio device 200 for disconnection from the electronic device 300, by using the SPP of Bluetooth.

According to an embodiment, the operation of the system may include an operation S1180 of terminating connection between the external audio device 200 and the electronic device 300. According to an embodiment, when the external audio device 200 receives the signal requesting disconnection from the electronic device 300 from the display device 100, the external audio device 200 may provide the signal requesting disconnection to the electronic device 300. According to an embodiment, when the electronic device 300 receives the signal requesting disconnection from the external audio device 200, the electronic device 300 may terminate connection of the HPP and A2DP of Bluetooth with the external audio device 200. At this time, the connection of the SPP of Bluetooth between the electronic device 300 and the external audio device 200 may be maintained.

According to an embodiment, the operation of the system may include an operation S1190 in which the display device 100 and the external audio device 200 are connected to each other. In the operation S1170 in which the display device 100 is connected to the external audio device 200, the display device 100 may request the external audio device 200 for connection. According to an embodiment, the display device 100 may request the external audio device 200 for connection through the SPP of Bluetooth. According to an embodiment, in the operation S1170 in which the display device 100 and the external audio device 200 are connected to each other, the HFP and A2DP between the display device 100 and the external audio device 200 may be connected.

Referring to FIGS. 4 and 5, in the operation S240 of determining whether the second control signal requesting provision of sound through the external audio device 200 has been obtained, it may be determined whether the display device 100 has been connected with the external audio device 200 again.

According to an embodiment, the operation of the system may include an operation S1200 of providing the sound 130 of the content through the external audio device 200. The display device 100 may provide the sound 130 of the content to the user 400 by unmuting the muted sound in the operation S1140 of muting the sound 130 of the content after the operation S11900 of connecting to the external audio device 200.

Referring to FIGS. 4 and 5, in the operation S250 of controlling the display 110 to display the image 120 of the content and controlling the communication interface 170 to provide the sound 130 of the content through the external audio device 200, the display device 100 may unmute the muted sound and provide the unmuted sound through the external audio device 200.

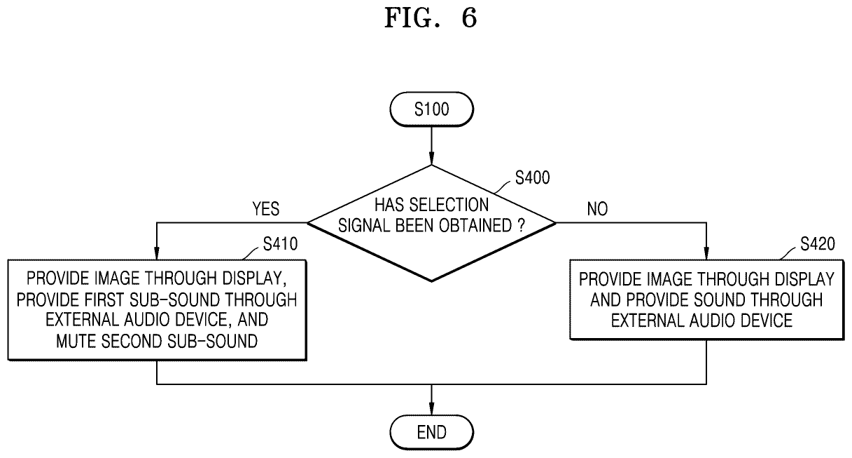

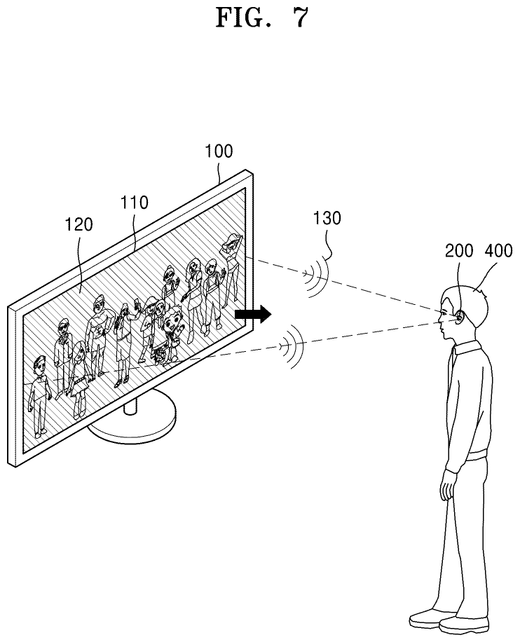

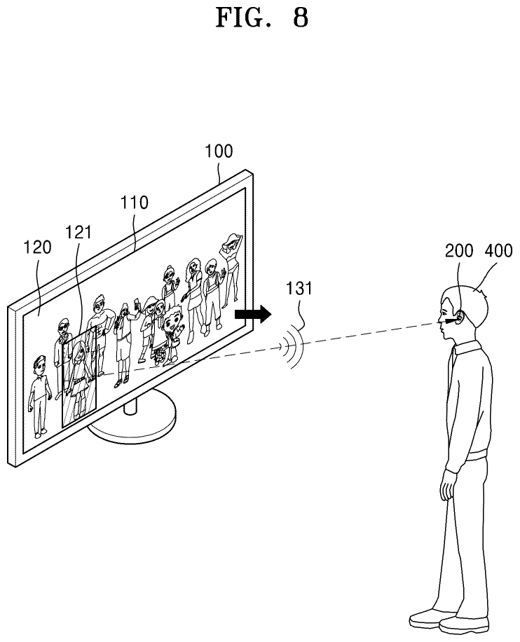

FIG. 6 is a flowchart of an operation of a display device according to whether a selection signal is obtained, according to an embodiment. FIG. 7 is a diagram illustrating an operation, performed by a display device according to an embodiment, of providing sound through an external audio device. FIG. 8 is a diagram illustrating an operation, performed by a display device according to an embodiment, of providing sound corresponding to content selected according to a selection signal, through an external audio device. The same structure and operation as those described above with reference to FIGS. 1 and 3 are given the same reference numerals, and reference may be made to the descriptions of FIGS. 1 and 3 for additional implementation details.

Referring to FIGS. 2, 6 and 7, according to an embodiment, the content may include a plurality of items of subcontent. The plurality of items of subcontent may include a human, an avatar corresponding to the human, a character, an animal, or an object. According to an embodiment, the plurality of items of subcontent may each include a corresponding sub-image and corresponding sub-sound. The display device 100 may display an image 120 including a plurality of sub-images respectively corresponding to the plurality of items of subcontent through the display 110, and may provide the image 120 to the user 400. The display device 100 may provide sound 130 including a plurality of sub-sounds respectively corresponding to the plurality of items of subcontent to the user 400 through the external audio device 200.

According to an embodiment, the content may be content representing virtual reality. Virtual reality may refer to a space which a plurality of users may access using Internet-connected devices such as televisions, mobile devices, laptop computers, desktops, tablet PCs, head mounted display devices, or wearable devices. The plurality of users connected to virtual reality may explore the virtual reality in various ways, and may interact with each other (e.g., conversation, economic activity, and play). In virtual reality, the plurality of users may create respective avatars, which are their digital representations, and may interact with other avatars within the virtual reality.

According to an embodiment, the user 400 illustrated in FIGS. 7 and 8 may be a user who is provided with content representing virtual reality by using the display device 100, from among the plurality of users connected to virtual reality. For convenience of explanation, the content provided by the display device 100 will now be described as being content representing the virtual reality accessed by the user 400.

Referring to FIGS. 6 and 8, according to an embodiment, the operation S200 of confirming connection with the external audio device 200 and operating in the second mode may include an operation S400 of determining whether a selection signal including information indicating selection of at least one item of subcontent 121 from among the plurality of items of subcontent has been obtained.

According to an embodiment, the selection signal may be generated in response to an operation in which the user 400 using the display device 100 touches the display 110 to select the at least one item of subcontent 121 from among the plurality of items of subcontent displayed on the display 110 or an operation in which the user 400 using the display device 100 selects the at least one item of subcontent 121 from among the plurality of items of subcontent by using a UI provided by the display device 100. The selection signal may also be generated based on an image generated by the user 400 selecting the at least one item of subcontent 121 from among the plurality of items of subcontent by using the electronic device 300 or an external electronic device, or based on coordinate information within the display 110.

According to an embodiment, when it is determined that the selection signal has been obtained, the operation S200 of operating in the second mode may include an operation of identifying the at least one item of subcontent 121, based on the obtained selection signal. According to an embodiment, the at least one processor 150 may identify the at least one item of subcontent 121 selected by the user 400 from among the plurality of items of subcontent, based on the coordinate information or image information included in the obtained selection signal, in the operation of identifying the at least one item of subcontent 121.

According to an embodiment, when the plurality of items of subcontent are avatars respectively corresponding to the plurality of users using virtual reality, the selection signal may include information about at least one avatar selected by the user 400 from among the plurality of avatars. The at least one processor 150 may identify the at least one avatar selected by the user 400 from among the plurality of avatars, based on the selection signal.

According to an embodiment, the operation S200 of operating in the second mode may include an operation S410 of controlling the display 110 to display the image 120 corresponding to the plurality of items of subcontent, providing a first sub-sound 131 corresponding to the identified at least one item of content 121 to the external audio device 200, controlling the communication interface 170 to stop providing a second sub-sound corresponding to the remaining items of subcontent not identified among the plurality of items of subcontent to the external audio device 200, and muting the second sub-sound.

According to an embodiment, in the operation S410 of providing the first sub-sound 131 and muting the second sub-sound, the at least one processor 150 may provide the first sub-sound 131 corresponding to the identified at least one item of content 121 among the plurality of items of subcontent to the external audio device 200, control the communication interface 170 to stop providing the second sub-sound corresponding to the remaining items of subcontent among the plurality of items of subcontent, and mute the second sub-sound.

According to an embodiment, when the plurality of items of subcontent are avatars respectively corresponding to a plurality of virtual reality users, the at least one processor 150 may provide an image corresponding to the plurality of avatars to the user 400 through the display 110. The at least one processor 150 may provide, to the user 400 through the external audio device 200, only the first sub-sound 131 corresponding to at least one avatar identified as being selected by the user 400 from among the plurality of avatars. The at least one processor 150 may mute the second sub-sound corresponding to the remaining avatars not selected by the user 400 from among the plurality of avatars.

According to an embodiment, a sub-sound corresponding to each of the plurality of items of subcontent may be a sound corresponding to communication provided by each of the plurality of avatars (e.g., sound corresponding to chatting, utterance, or an emoticon sound effect). When the at least one processor 150 has obtained the selection signal and has identified the at least one avatar selected by the user 400, the at least one processor 150 may provide, to the user 400, only sound corresponding to communication provided by the at least one avatar. Accordingly, the user 400 may focus on communicating with the selected avatar without being disturbed by sounds corresponding to communications of the remaining unselected avatars. The user may perform non-public communication with the selected avatar by preventing the sound corresponding to communication with the selected avatar from being provided to the surroundings by the display device 100. Accordingly, the privacy of the user 400 may be protected.

However, the disclosure is not limited thereto. According to an embodiment, when the plurality of items of subcontent include objects or animals included in virtual reality, the sub-sound corresponding to each of the plurality of items of subcontent may include sound corresponding to a pre-stored description of an object, or an animal sound, for example. The user 400 may select at least one item of subcontent that he or she wants to listen to intensively from among the plurality of items of subcontent, and thus may receive only the sound corresponding to the selected subcontent through the external audio device 200. According to an embodiment, the user 400 may select at least one object whose description he or she wants to hear, in a virtual reality where a plurality of objects exist, such as a museum, and receive the description of the selected object. The user 400 may select at least one animal whose sound he or she wants to hear, in a virtual reality where a plurality of animals exist, such as a museum, and receive the sound of the selected animal.

According to an embodiment, when it is determined that the selection signal has been obtained, in the operation S400 of determining whether the selection signal has been obtained, the operation method of the display device 100 may include an operation S420 of controlling the display 110 to display the image 120 corresponding to the plurality of items of subcontent and controlling the communication interface 170 to provide the sound 130 corresponding to the plurality of items of subcontent to the external audio device 200.

According to an embodiment, when the plurality of items of subcontent are avatars respectively corresponding to a plurality of users using virtual reality, the at least one processor 150 may provide the image 120 corresponding to the plurality of avatars to the user 400 through the display 110. The at least one processor 150 may provide communications provided by the plurality of avatars to the user 400 via the external audio device 200.

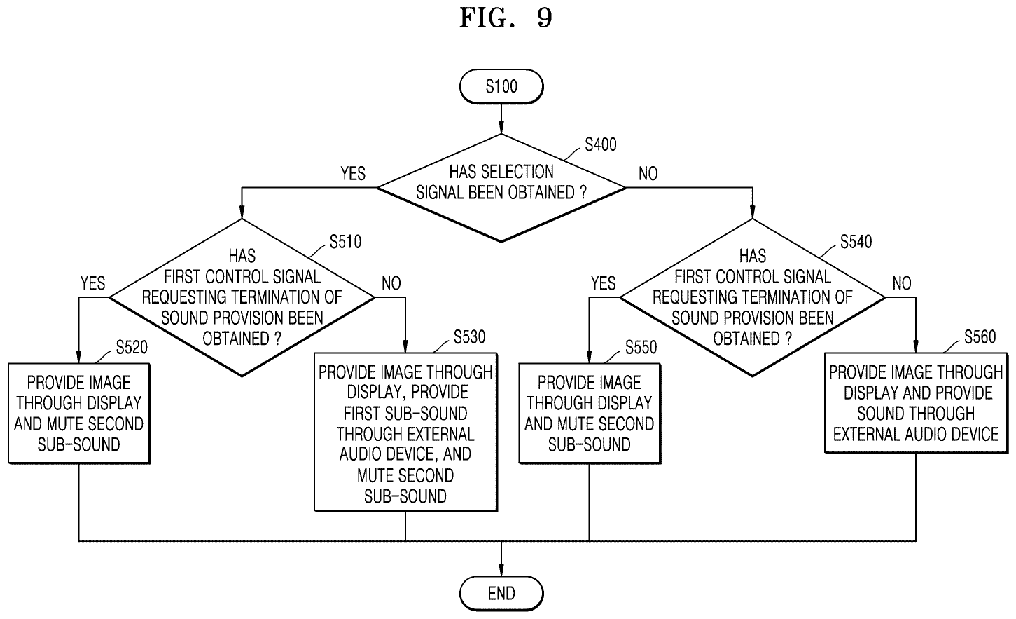

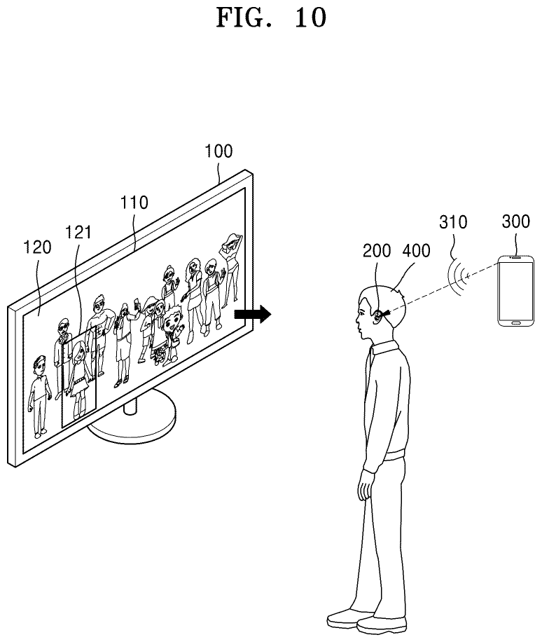

FIG. 9 is a flowchart of an operation of a display device according to whether a first control signal requesting termination of sound provision has been obtained after obtainment of a selection signal, according to an embodiment. FIG. 10 is a view illustrating an operation of a display device when the first control signal requesting termination of sound provision has been obtained after obtainment of a selection signal, according to an embodiment. The same structure and operations as those described above with reference to FIGS. 3, 6, 7, and 8 are given the same reference numerals, and reference may be made to the descriptions of FIGS. 3, 6, 7, and 8 for additional implementation details.

Referring to FIGS. 2, 9, and 10, the operation method of the display device 100 may further include an operation S510 of determining whether the first control signal requesting termination of sound provision has been obtained, after obtainment of the selection signal.

According to an embodiment, the operation method of the display device 100 may include, when the first control signal has been obtained, an operation S520 of controlling the display 110 to display the image 120 corresponding to the plurality of items of subcontent, stopping providing the first sub-sound corresponding to the identified at least one item of subcontent 121 to the external audio device 200, and muting the first sub-sound. In the operation S520 of muting the first sub-sound, the second sub-sound corresponding to the remaining items of subcontent may also be muted. According to an embodiment, when the first control signal has been obtained, the at least one processor 150 may control the display 110 to display the image 120 corresponding to the plurality of items of subcontent. The at least one processor 150 may stop providing the first sub-sound corresponding to the identified at least one item of subcontent 121 to the external audio device 200, and may mute the first sub-sound. The at least one processor 150 may maintain a state in which the second sub-sound corresponding to the remaining items of subcontent is muted. The user 400 may receive the sound 310 provided by the electronic device 300, through the external audio device 200.

According to an embodiment, the operation method of the display device 100 may include, when the first control signal has not been obtained, an operation S530 of controlling the display 110 to display the image 120 corresponding to the plurality of items of subcontent, providing the first sub-sound 131 of FIG. 8 to the external audio device 200, and muting the second sub-sound. According to an embodiment, the at least one processor 150 may provide the image 120 corresponding to the plurality of items of subcontent to the user 400 through the display 110, provide the first sub-sound 131 to the user 400 through the external audio device 200, and mute the second sub-sound.

According to an embodiment, when the selection signal has not been obtained, the operation method of the display device 100 may further include an operation S540 of determining whether the first control signal requesting termination of sound provision has been obtained.

According to an embodiment, when the selection signal has not been obtained and the first control signal has been obtained, the operation method of the display device 100 may include an operation S550 of controlling the display 110 to display the image 120 corresponding to the plurality of items of subcontent, and muting the first sub-sound corresponding to the identified at least one item of subcontent and the second sub-sound corresponding to the remaining items of subcontent. According to an embodiment, the at least one processor 150 may provide the image 120 corresponding to the plurality of items of subcontent to the user 400 through the display 110, and mute the first sub-sound corresponding to the identified at least one item of subcontent and the second sub-sound corresponding to the remaining items of subcontent.

According to an embodiment, when the selection signal has not been obtained and the first control signal has not been obtained, the operation method of the display device 100 may include an operation S560 of providing the image 120 corresponding to the plurality of items of subcontent through the display 110, and providing the sound 130 of FIG. 7 corresponding to the plurality of items of subcontent through the external audio device 200. According to an embodiment, the at least one processor 150 may provide the image 120 corresponding to the plurality of items of subcontent to the user 150 through the display 110, and provide the sound 130 of FIG. 7 corresponding to the plurality of items of subcontent to the user 150 through the external audio device 200.

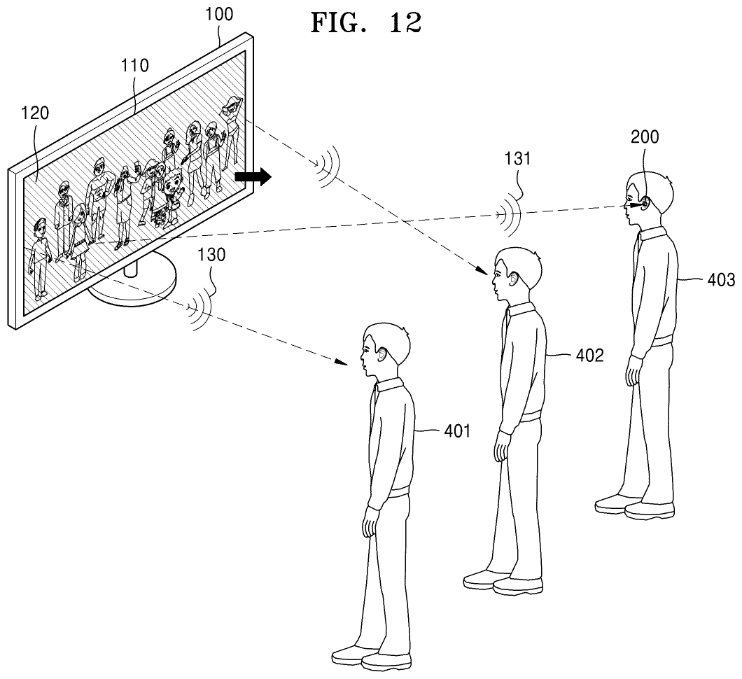

FIG. 11 is a flowchart of an operation, in a third mode, of a display device according to whether an operation signal has been obtained, according to an embodiment. FIG. 12 is a view illustrating an operation of a display device in a third mode according to an embodiment. The same structure and operations as those described above with reference to FIGS. 3, 6, 7, and 8 are given the same reference numerals, and reference may.

Referring to FIGS. 2, 11, and 12, according to an embodiment, the operation method of the display device 100 may include an operation S50 of determining whether an operation signal including information indicating that a plurality of users use the display device 100 has been obtained.

According to an embodiment, a plurality of users 401, 402, and 403 illustrated in FIG. 12 may be users connected to virtual reality. The display device 100 may provide content corresponding to virtual reality accessed by the plurality of users 401, 402, and 403 to the plurality of users 401, 402, and 403. However, the disclosure is not limited thereto, and other users in addition to the plurality of users 401, 402, and 403 using the display device 100 may be connected to the virtual reality.

According to an embodiment, the content may include a plurality of items of subcontent. Each of the plurality of items of subcontent may be an avatar corresponding to each of the plurality of users 401, 402, and 403 using the virtual reality. However, the disclosure is not limited thereto, and the plurality of items of subcontent may include avatars of the other users connected to the virtual reality in addition to the plurality of users 401, 402, and 403.

According to an embodiment, the operation signal may include information indicating that the plurality of users 401, 402, and 403 use the display device 100.

According to an embodiment, when it is determined that the operation signal has been obtained, the operation method of the display device 100 may include an operation S610 of determining whether at least one user 403 among the plurality of users 401, 402, and 403 has been connected to the external audio device 200 of the at least one user 403 through the communication interface 170. Although FIG. 11 illustrates that the external audio device 200 worn by one user 403 among the plurality of users 401, 402, and 403 is connected to the display device 100, the disclosure is not limited thereto. An external audio device worn by two or more users among a plurality of users using the display device 100 may be connected to the display device 100.

Hereinafter, for convenience of explanation, the external audio device 200 worn by at least one user 403 may be referred to as a sub audio device (e.g., sub audio source) 200.

According to an embodiment, the at least one processor 150 may determine whether the sub audio device 200 of the at least one user 403 among the plurality of users 401, 402, and 403 has been connected to the display device 100 via the communication interface 170.

According to an embodiment, when the operation signal has been obtained and it is determined that the display device 100 has been connected to the sub audio device 200 of the at least one user 403, the operation method of the display device 100 may include an operation S620 of operating in a third mode for providing content corresponding to virtual reality to the plurality of users 401, 402, and 403. According to an embodiment, in the operation S620 of operating in the third mode, the at least one processor 150 may control the display 110 to display the image 120 corresponding to the content. The at least one processor 150 may provide the image 120 corresponding to the content to the plurality of users 401, 402, and 403. The at least one processor 150 may control the communication interface 170 to provide the sound 131 corresponding to the content to the external audio device 200. The at least one processor 150 may provide the sound 131 corresponding to the content to the at least one user 403 through the sub audio device 200. The at least one processor 150 may control the audio device 160 to output the sound 130 corresponding to the content. The at least one processor 150 may provide the sound 130 corresponding to the content to the remaining users 401 and 402 through the audio device 160.

Accordingly, among the plurality of users 401, 402, and 403 who are provided with the image 120 of the content corresponding to virtual reality through the display device 100, the sound 131 of the content may be provided to the user 403 wearing the external audio device 200 through the external audio device 200, and the sound 130 of the content may be provided to the users 401 and 402 who are not wearing the external audio device 200 through the audio device 160 included in the display device 100, thereby providing various user experiences to the plurality of users 401, 402, and 403 using the display device 100.

According to an embodiment, when the operation signal has been obtained and the display device 100 has not been connected with the sub audio device 200, the operation method of the display device 100 may include an operation S630 of controlling the display 110 to provide the image 120 corresponding to the content and controlling the audio device 160 to output the sound 130 corresponding to the content. According to an embodiment, the at least one processor 150 may provide the image 120 corresponding to the content to the plurality of users 401, 402, and 403 through the display 110 and provide the sound 130 corresponding to the content to the plurality of users 401, 402, and 403 through the audio device 160.

According to an embodiment, when the operation signal has not been obtained, the operation method of the display device 100 may include an operation S100 of determining whether the display device 100 has been connected to the external audio device 200. When it is determined that the display device 100 has been connected to the external audio device 200, the operation method of the display device 100 may include an operation S200 of operating in the second mode shown in FIG. 3. When the display device 100 has not been connected to the external audio device 200, the operation method of the display device 100 may include an operation S300 of operating in the first mode shown in FIG. 3.

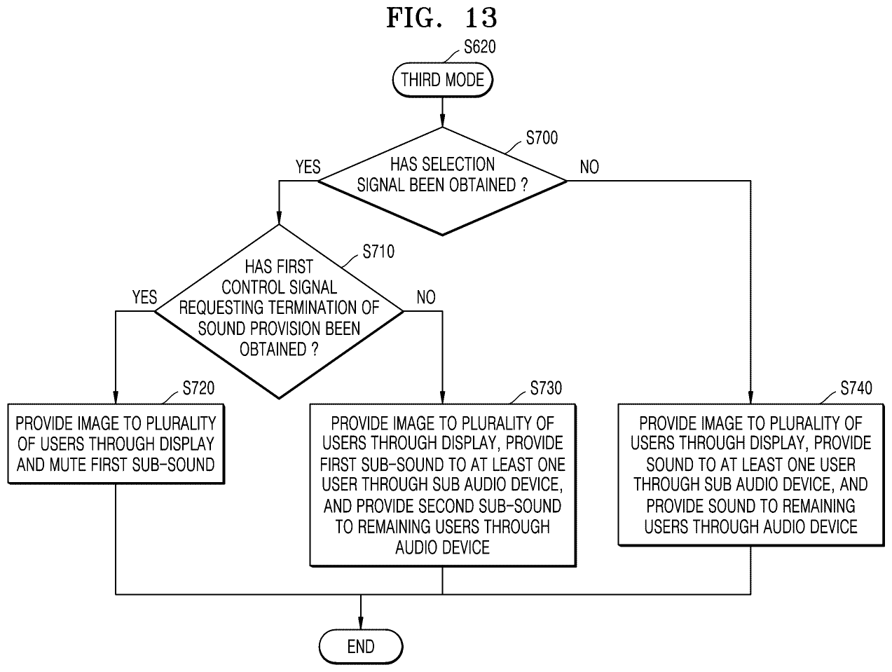

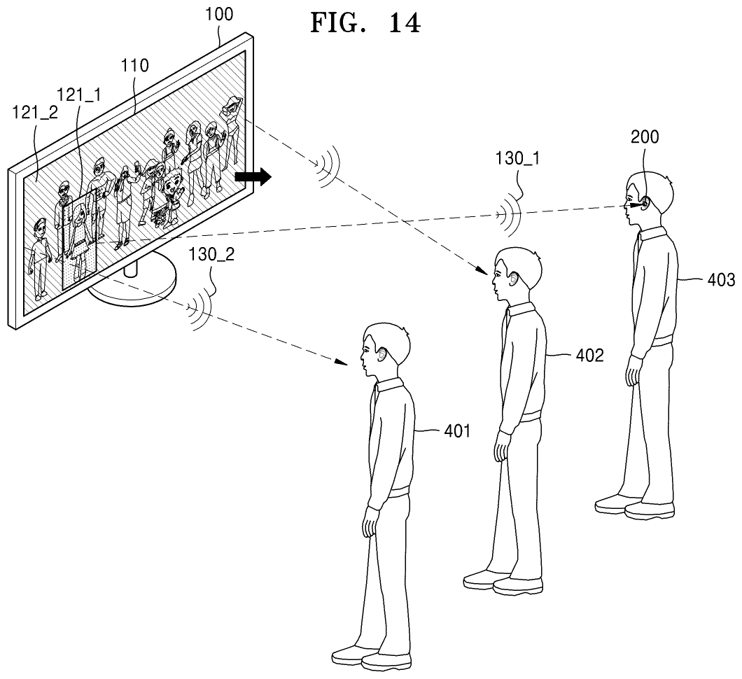

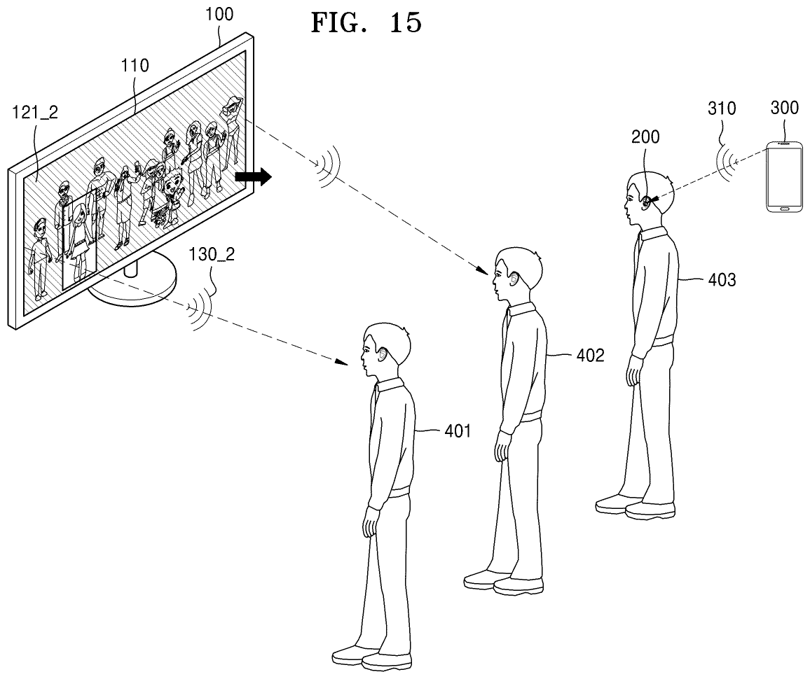

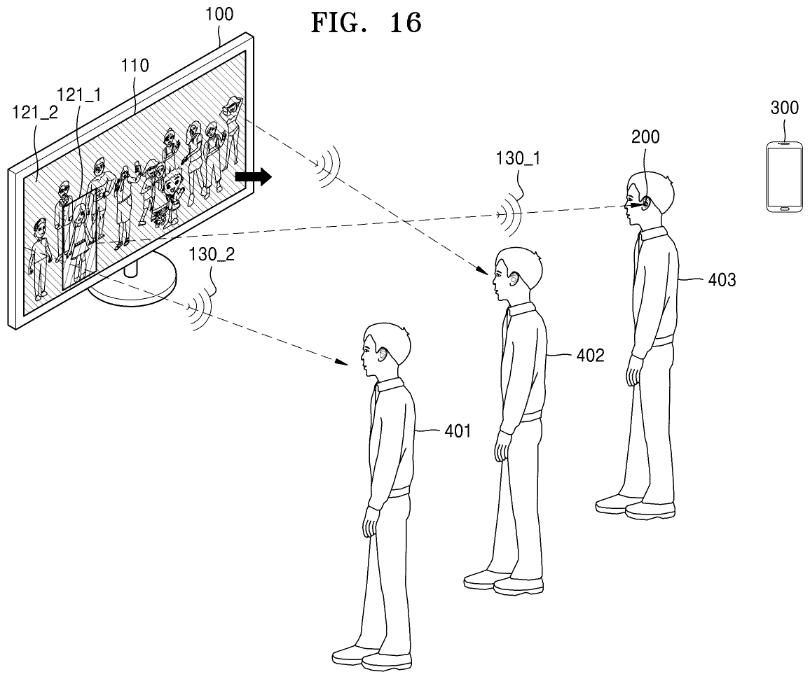

FIG. 13 is a flowchart of an operation of a display device according to whether a selection signal is obtained, in a third mode, according to an embodiment. FIG. 14 is a view illustrating an operation of a display device when a selection signal has been obtained, in a third mode, according to an embodiment. FIG. 15 is a view illustrating an operation of a display device when the first control signal has been obtained, after obtainment of an operation signal and a selection signal, according to an embodiment. FIG. 16 is a view illustrating an operation of a display device when the second control signal has been obtained, after obtainment of the operation signal, the selection signal, and the first control signal, according to an embodiment. The same structure and operations as those described above with reference to FIGS. 11 and 12 are given the same reference numerals, and redundant descriptions thereof are omitted.

Referring to FIGS. 13 and 14, according to an embodiment, the operation S620 of obtaining the operation signal and operating in the third mode by connection with the sub audio device 200 may include an operation S700 of determining whether a selection signal including information indicating selection of at least one item of subcontent 121_1 from among a plurality of items of subcontent 121_1 has been obtained.

According to an embodiment, the selection signal may be a signal generated in response to an operation in which at least one user 403 wearing the sub audio device 200 selects one item of subcontent 121_1 from among a plurality of items of subcontent 121_1 and 121_2. According to an embodiment, when each of the plurality of items of subcontent 121_1 and 121_2 is an avatar corresponding to each of the plurality of users 401, 402, and 403, the selection signal may be a signal generated in response to an action of selecting one avatar from among a plurality of avatars. However, the disclosure is not limited thereto, and the plurality of items of subcontent 121_1 and 121_2 may include avatars corresponding to other users connected to the virtual reality in addition to the plurality of users 401, 402, and 403.

According to an embodiment, FIG. 14 illustrates that the plurality of items of subcontent 121_1 and 121_2 further include avatars corresponding to other users connected to the virtual reality in addition to the plurality of users 401, 402, and 403, and the selection signal is a signal corresponding to an action of selecting one avatar from among a plurality of avatars. However, the disclosure is not limited thereto. The at least one user 403 may select two or more avatars, and the selection signal may be a signal generated in response to an action of selecting two or more avatars.

According to an embodiment, when it is determined that the selection signal has been obtained, the operation S620 of operating in the third mode may include an operation of identifying at least one item of subcontent 121_1 from among the plurality of items of subcontent 121_1 and 121_2, based on the obtained selection signal. According to an embodiment, the at least one processor 150 may identify the at least one item of subcontent 121_1 selected by at least one user 403 from among the plurality of items of subcontent 121_1 and 121_2, based on the coordinate information or image information included in the obtained selection signal.

According to an embodiment, when the plurality of items of subcontent are a plurality of avatars, respectively, the at least one processor 150 may identify the at least one avatar selected by the at least one user 403 from among the plurality of avatars, based on the selection signal.

According to an embodiment, when at least one item of subcontent 121_1 is identified, the operation S620 of operating in the third mode may further include an operation of controlling the display 110 to display the image 120 corresponding to the plurality of items of subcontent, controlling the communication interface 170 to provide a first sub-sound 130_1 corresponding to the identified at least one item of subcontent 121_1 to the sub audio device 200, and controlling the audio device 160 of the display device 100 to output a second sub-sound 130_2 corresponding to the remaining items of subcontent 121_2.

According to an embodiment, in the third mode, the at least one processor 150 may control the display 110 to display the image 120 corresponding to the plurality of items of subcontent. The at least one processor 150 may provide the image 120 corresponding to the plurality of items of subcontent to the plurality of users 401, 402, and 403 through the display 11. The at least one processor 150 may control the communication interface 170 to provide the first sub-sound 130_1 corresponding to the identified at least one item of subcontent 121_1 to the sub audio device 200. The at least one processor 150 may provide the first sub-sound 130_1 corresponding to the identified at least one item of subcontent 121_1 to the at least one user 403 through the sub audio device 200. The at least one processor 150 may control the audio device 160 of the display device 100 to output the second sub-sound 130_2 corresponding to the remaining items of subcontent 121_2. The at least one processor 150 may provide the second sub-sound 130_2 corresponding to the remaining items of subcontent 121_2 to the remaining users 401 and 402 through the audio device 160.

Accordingly, the sound 130_1 corresponding to communication with at least one avatar from among a plurality of avatars existing in virtual reality may be provided, through the sub audio device 200, only to at least one user 403 who wishes to perform non-public communication with the selected at least one avatar, so that the privacy of the at least one user 403 may be protected. The remaining users 401 and 402 using the display device 100 may be provided with the remaining sound 130_2 except for non-public communication between the at least one user 403 and the selected avatar, so as not to disturb user experience of the remaining users 401 and 402.

Referring to FIGS. 13 and 15, the operation S620 of operating in the third mode may further include an operation S710 of determining whether the first control signal requesting termination of sound provision has been obtained.

According to an embodiment, when it is determined that the first control signal has been obtained, the operation S620 of operating in the third mode may include an operation S720 of controlling the display 110 to display the image 120, controlling the communication interface 170 to stop providing the first sub-sound 130_1 to the sub audio device 200, and muting the first sub-sound 130_1. According to an embodiment, in operation S720 of muting the first sub-sound 130_1, the second sub-sound 130_2 may be continuously provided to the remaining users 401 and 402 through the audio device 160.

According to an embodiment, the at least one processor 150 may control the display 110 to display the image 120. The at least one processor 150 may provide the image 120 to the plurality of users 401, 402, and 403 through the display 110. The at least one processor 150 may control the communication interface 170 to stop providing the first sub-sound 130_1 to the sub audio device 200, and may mute the first sub-sound 130_1. The at least one processor 150 may provide the second sub-sound 130_2 to the remaining users 401 and 402 via the audio device 160. Accordingly, the privacy of at least one user 403 who wanted to have a non-public communication with the selected avatar may be protected.

According to an embodiment, when the first control signal has not been obtained, the operation S620 of operating in the third mode may include an operation S730 of providing the image 120 corresponding to the plurality of items of subcontent to the plurality of users 401, 402, and 403 through the display 110, providing the first sub-sound 130_1 to the at least one user 403 through the sub audio device 200, and providing the second sub-sound 130_2 corresponding to the remaining items of subcontent 121_2 to the remaining users 401 and 402 through the audio device 160 of the display device 100.

Referring to FIGS. 13 and 16, according to an embodiment, the operation method of the display device 100 may further include an operation of determining whether the second control signal requesting provision of sound through the sub audio device 200 has been obtained, after the operation S720 of muting the first sub-sound in response to obtainment of the first control signal, in the operation S620 of operating in the third mode.

According to an embodiment, when the second control signal has been obtained, the operation S620 of operating in the third mode may further include an operation of providing the image 120 corresponding to the plurality of items of subcontent to the plurality of users 401, 402, and 403 through the display 110, providing the first sub-sound 130_1 to the at least one user 403 through the sub audio device 200, and providing the second sub-sound 130_2 corresponding to the remaining items of subcontent 121_2 to the remaining users 401 and 402 through the audio device 160 of the display device 100.

According to an embodiment, when the first control signal has been obtained, the at least one processor 150 may provide the image 120 corresponding to the plurality of items of subcontent to the plurality of users 401, 402, and 403 through the display 110, unmuting the muted first sub-sound 130_1 and providing the unmuted first sub-sound 130_1 to the at least one user 403 through the sub audio device 200, and providing the second sub-sound 130_2 corresponding to the remaining items of subcontent 121_2 to the remaining users 401 and 402 through the audio device 160 of the display device 100.

According to an embodiment, when it is determined that the selection signal has not been obtained, the operation S620 of operating in the third mode may include an operation S800 of providing the image 120 corresponding to the plurality of items of subcontent to the plurality of users 401, 402, and 403 through the display 110, providing the sound 131 of FIG. 12 to the at least one user 403 through the sub audio device 200, and providing the sound 130 of FIG. 12 of the content to the remaining users 401 and 402 through the audio device 160.

In order to address the above-described technical problems, according to an embodiment, a display device for providing content is provided. The display device may include a display. The display device may include an audio device. The display device may include a communication interface. The display device may include a memory storing at least one instruction. The display device may include at least one processor configured to execute the at least one instruction stored in the memory, The at least one processor may be configured to operate in a first mode of controlling the display to display an image corresponding to the content and controlling the audio device to output a sound corresponding to the content. The at least one processor may be configured to operate in a second mode of controlling the display to display the image and controlling the communication interface to provide the sound to an external audio device connected to the display. The at least one processor may be configured to operate in one of the first mode or the second mode. While operating in the second mode, when a first control signal requesting to stop providing the sound through the external audio device has been obtained, the at least one processor may be configured to control the display to display the image. The at least one processor may be configured to control the communication interface to stop providing the sound to the external audio device. The at least one processor may be configured to mute the sound.

According to an embodiment, the first control signal may be a signal generated from at least one of an electronic device connected to the external audio device or the external audio device connected to the electronic device, in response to occurrence of an event of providing sound from the electronic device to the external audio device.

According to an embodiment, the first control signal may be a signal generated when the electronic device receives a call signal.

According to an embodiment, the at least one processor is configured to, after the sound whose provision has been stopped in response to obtainment of the first control signal is muted in the second mode, when a second control signal requesting provision of the sound through the external audio device has been obtained, control the display to display the image and control the communication interface to output the sound to the external audio device.

According to an embodiment, the second control signal may be a signal generated from at least one of the electronic device connected to the external audio device or the external audio device connected to the electronic device.

According to an embodiment, the content may include a plurality of items of subcontent. The at least one processor may be configured to, in the second mode, when a selection signal including information indicating selection of at least one item of subcontent from among the plurality of items of subcontent has been obtained, identify the at least one item of content, based on the selection signal. The at least one processor may be configured to control the display to display an image corresponding to the plurality of items of subcontent. The at least one processor may be configured to provide a first sub-sound corresponding to the identified at least one item of subcontent to the external audio device. The at least one processor may be configured to control the communication interface to stop providing a second sub-sound corresponding to remaining items of subcontent among the plurality of items of subcontent. The at least one processor may be configured to mute the second sub-sound.

According to an embodiment, the at least one processor may be configured to, when the first control signal is obtained after the selection signal has been obtained, control the display to display the image. The at least one processor may be configured to stop provision of the first sub-sound to the external audio device. The at least one processor may be configured to mute the first sub-sound.

According to an embodiment, the content may include a plurality of items of subcontent. As an operation signal including information indicating that a plurality of users use the display device is obtained, and the at least one processor is connected to a sub audio device of at least one user among the plurality of users through the communication interface, the at least one processor may be configured to control the display to display image corresponding to the plurality of items of subcontent. The at least one processor may be configured to control the communication interface to provide sounds corresponding to the plurality of items of subcontent to the sub audio device. The at least one processor may be configured to operate in a third mode of controlling the audio device to output the sound corresponding to the plurality of items of subcontent.

According to an embodiment, the at least one processor may be configured to obtain a selection signal including information indicating that the at least one user has selected at least one item of subcontent from among the plurality of items of subcontent in the third mode. The at least one processor may be configured to identify the at least one item of subcontent, based on the obtained selection signal. The at least one processor may be configured to control the display to display the image corresponding to the plurality of items of subcontent. The at least one processor may be configured to control the communication interface to provide the first sub-sound corresponding to the identified at least one item of subcontent to the sub audio device. The at least one processor may be configured to control the audio device to output a second sub-sound corresponding to remaining items of subcontent among the plurality of items of subcontent.

According to an embodiment, when the first control signal is obtained after the selection signal has been obtained, the at least one processor may be configured to control the display to display the image corresponding to the plurality of items of subcontent. The at least one processor may be configured to control the communication interface to stop providing the first sub-sound to the sub audio device, and may mute the first sub-sound.

In order to address the above-described technical problems, according to an embodiment, an operation method of a display device for providing content is provided. The operation method of the display device may include determining whether the display device and an external audio device have been connected to each other through a communication interface. The operation method of the display device may include, when the display device has not been connected to the external audio device, operating in a first mode of controlling a display to display an image corresponding to the content and controlling an audio device to output sound corresponding to the content. The operation method of the display device may include, when the display device has been connected to the external audio device, operating in a second mode of controlling the display to display the image and controlling a communication interface to provide the sound to the external audio device. In the operation method of the display device, when a first control signal requesting to stop providing the sound through the external audio device has been obtained in the operation of operating in the second mode, the display may be controlled to display the image, the communication interface may be controlled to stop providing the sound to the external audio device, and the sound may be muted.

According to an embodiment, the operation method of the display device may include, after the first control signal has been obtained and thus the sound is muted in the operation of operating in the second mode, when a second control signal requesting to provide the sound through the external audio device has been obtained, controlling the display to display the image and controlling the communication interface to output the sound through the external audio device.

According to an embodiment, the content may include a plurality of items of subcontent. The operation of operating in the second mode may include determining whether a selection signal including information indicating selection of at least one item of subcontent from among the plurality of items of subcontent has been obtained. The operation of operating in the second mode may include identifying the at least one item of subcontent, based on the obtained selection signal. The operation of operating in the second mode may include controlling the display to display the image corresponding to the plurality of items of subcontent, providing a first sub-sound corresponding to the identified at least one item of subcontent to the external audio device, controlling the communication interface to stop providing a second sub-sound corresponding to the remaining items of subcontent among the plurality of items of subcontent to the external audio device, and muting the second sub-sound.

According to an embodiment, in the operation method of the display device, when the first control signal has been obtained after the selection signal has been obtained in the operation of operating in the second mode, the display may be controlled to display the image, the communication interface may be controlled to stop providing the first sub-sound to the external audio device, and the first sub-sound may be muted.

According to an embodiment, the content may include a plurality of items of subcontent. The operation method of the display device may include determining whether an operation signal including information indicating that a plurality of users use the display device has been obtained. The operation method of the display device may include determining whether the display device have been connected to a sub audio device of at least one user among the plurality of users through a communication interface. In the operation method of the display device, the display device may operate in a third mode of controlling the display to display the image corresponding to the plurality of items of subcontent, controlling the communication interface to provide sounds corresponding to the plurality of items of subcontent to the sub audio device, and controlling the audio device to output the sounds corresponding to the plurality of items of subcontent.

According to an embodiment, the operation of operating in the third mode may include determining whether a selection signal including information indicating that at least one user has selected at least one item of subcontent from among the plurality of items of subcontent has been obtained. The operation of operating in the third mode may include identifying the at least one item of subcontent, based on the obtained selection signal. The operation of operating in the third mode may include controlling the display to display the image included in the plurality of items of subcontent, controlling the communication interface to provide the first sub-sound corresponding to the identified at least one item of subcontent to the sub audio device, and controlling the audio device to output the second sub-sound corresponding to the remaining items of subcontent among the plurality of items of subcontent.

According to an embodiment, the operation of operating in the third modem may include, when the first control signal has been obtained after the selection signal has been obtained, controlling the display to display the image corresponding to the plurality of items of subcontent, controlling the communication interface to stop providing the first sub-sound to the sub audio device, and muting the first sub-sound.

According to an embodiment, provided is a computer-readable recording medium having recorded thereon a computer program, which, when executed by a computer, performs at least one of the above-disclosed methods.

The program executed by the display device described above herein may be implemented as a hardware component, a software component, and/or a combination of hardware components and software components. The program may be executed by any system capable of executing computer readable instructions.

The software may include a computer program, a code, instructions, or a combination of one or more of the foregoing, and may constitute a processing device so that the processing device can operate as desired, or may independently or collectively instruction the processing device.

The software may be implemented as a computer program including instructions stored in computer-readable storage media. Examples of the computer-readable recording media include magnetic storage media (ROM, floppy disks, or hard disks, for example), and optical recording media (e.g., CD-ROMs, or digital versatile discs (DVDs)). The computer-readable recording media can be distributed over network coupled computer systems so that the computer-readable code is stored and executed in a distributive manner. These recording media can be read by the computer, stored in a memory, and executed by a processor.

A computer-readable storage medium may be provided as a non-transitory storage medium. The ‘non-transitory storage medium’ is a tangible device and only means that it does not contain a signal (e.g., electromagnetic waves). This term does not distinguish a case in which data is stored semi-permanently in a storage medium from a case in which data is temporarily stored. For example, the non-transitory recording medium may include a buffer in which data is temporarily stored.

Programs according to various embodiments disclosed herein may be provided by being included in computer program products. The computer program product, which is a commodity, may be traded between sellers and buyers.

Computer program products may include a software program and a computer-readable storage medium having the software program stored thereon. For example, computer program products may include a product in the form of a software program (e.g., a downloadable application) that is electronically distributed through display device manufacturers or electronic markets (e.g., Samsung Galaxy Store). For electronic distribution, at least a portion of the software program may be stored on a storage medium or may be created temporarily. The storage medium may be a server of a manufacturer of a display device, a server of an electronic market, or a storage medium of a relay server for temporarily storing a software program.

Although the embodiments have been described with the limited embodiments and the drawings, various modifications and changes may be made by those of skill in the art from the above description. For example, an appropriate result may be attained even when the above-described techniques are performed in a different order from the above-described method, and/or components, such as the above-described computer system or module, are coupled or combined in a different form from the above-described methods or substituted for or replaced by other components or equivalents thereof.

What is claimed is:

1. A display device for providing content, the display device comprising:
a display;
an audio device;
a communication interface;
memory storing instructions; and
at least one processor, wherein the instructions, when executed by the at least one processor, cause the display device to:
determine whether the display device and an external audio device are connected via the communication interface;
based on the display device not being connected to the external audio device, operate in a first mode that controls the display to display a first image corresponding to the content and controls the audio device to output a first sound corresponding to the content;
based on the display device being connected to the external audio device, operate in a second mode that controls the display to display the first image and controls the communication interface to output the first sound via the external audio device; and
based on operating in the second mode, in response to receiving a first control signal indicating a request to stop outputting the first sound via the external audio device, control the display to display the first image, control the communication interface to stop outputting the first sound via the external audio device, and mute the first sound.

2. The display device of claim 1, wherein the first control signal is generated from at least one of an electronic device connected to the external audio device or the external audio device, in response to the first sound being output from the electronic device via the external audio device.

3. The display device of claim 2, wherein the first control signal is generated based on the electronic device receiving a call signal.

4. The display device of claim 1, wherein the instructions, when executed by the at least one processor, cause the display device to:
based on operating in the second mode, the output of the first sound being stopped in response to the first control signal, and the first sound being muted, in response to receiving a second control signal indicating a request to output the first sound via the external audio device, control the display to display the first image and control the communication interface to output the first sound via the external audio device.

5. The display device of claim 4, wherein the second control signal is generated from at least one of an electronic device or the external audio device.

6. The display device of claim 1, wherein the content comprises a plurality of items of subcontent, and
wherein the instructions, when executed by the at least one processor, cause the display device to, based on operating in the second mode, in response to receiving a selection signal indicating a selection of at least one item of subcontent from among the plurality of items:
identify the at least one item, based on the selection signal,
control the display to display a second image corresponding to the plurality of items, and
output a first sub-sound corresponding to the at least one item via the external audio device, control the communication interface to stop outputting a second sub-sound corresponding to one or more remaining items of subcontent from among the plurality of items, and mute the second sub-sound.

7. The display device of claim 6, wherein the instructions, when executed by the at least one processor, cause the display device to, based on the selection signal and the first control signal being received:
control the display to continue displaying the second image, stop outputting the first sub-sound via the external audio device, and mute the first sub-sound.

8. The display device of claim 1, wherein the content comprises a plurality of items of subcontent, and
wherein the instructions, when executed by the at least one processor, cause the display device to, based on receiving an operation signal indicating that a plurality of users use the display device and the display device being connected, via the communication interface, to a sub audio device of at least one user from among the plurality of users:
operate in a third mode that controls the display to display a second image corresponding to the plurality of items, controls the communication interface to output, via the sub audio device, a second sound corresponding to the plurality of items, and controls the audio device to output the second sound.

9. The display device of claim 8, wherein the instructions, when executed by the at least one processor, cause the display device to:
based on operating in the third mode and the at least one user receiving a selection signal indicating selection of at least one item of subcontent from among the plurality of items,
identify the at least one item, based on the selection signal;
control the display to display a third image included in the plurality of items; and
control the communication interface to output, via the sub audio device, a first sub-sound corresponding to the at least one item, and control the audio device to output a second sub-sound corresponding to one or more remaining items of subcontent from among the plurality of items.

10. The display device of claim 9, wherein the instructions, when executed by the at least one processor, cause the display device to, based on the selection signal and the first control signal being received:
control the display to display the second image, control the communication interface to stop outputting the first sub-sound via the sub audio device, and mute the first sub-sound.

11. An operation method of a display device for providing content, the operation method comprising:
determining whether the display device and an external audio device are connected via a communication interface;
based on the display device not being connected to the external audio device, operating in a first mode that controls the display device to display a first image corresponding to the content and controls an audio device to output a first sound corresponding to the content;
based on the display device being connected to the external audio device, operating in a second mode that controls the display device to display the first image and controls the communication interface to output the first sound to the external audio device; and
based on operating in the second mode, in response to receiving a first control signal indicating a request to stop outputting the first sound via the external audio device, controlling the display device to display the first image, controlling the communication interface to stop outputting the first sound via the external audio device, and muting the first sound.

12. The operation method of claim 11, wherein
the first control signal is generated from at least one of an electronic device connected to the external audio device or the external audio device, in response to the first sound being output from the electronic device via the external audio device.

13. The operation method of claim 11, further comprising,
based on operating in the second mode, the first sound output being stopped in response to the first control signal, and the first sound being muted,
in response to receiving a second control signal indicating a request to output the first sound via the external audio device, controlling the display device to display the first image and controlling the communication interface to output the first sound via the external audio device.

14. The operation method of claim 13, wherein
the second control signal is generated from at least one of an electronic device or the external audio device.

15. The method of claim 11, wherein the content comprises a plurality of items of subcontent,
wherein the operating in the second mode comprises:
determining whether a selection signal indicating a selection of at least one item of subcontent from among the plurality of items of subcontent from among the plurality of items has been obtained,
identifying the at least one item, based on the obtained selection signal,
controlling the display to display a second image corresponding to the plurality of items, outputting a first sub-sound corresponding to the at least one item via the external audio device, controlling the communication interface to stop outputting a second sub-sound corresponding to one or more remaining items of subcontent from among the plurality of items to the external audio device, and muting the second sub-sound.

16. The method of claim 15, wherein the operating in the second mode comprises, based on the selection signal and the first control signal have been received, controlling the display to continue displaying the second image, controlling the communication interface to stop outputting the first sub-sound via the external audio device, and muting the first sub-sound.

17. The method of claim 11, wherein the content comprises a plurality of items of subcontent,
wherein the operation method further comprises:
determining whether an operation signal indicating that a plurality of users use the display device has been obtained,
determining whether the display device has been connected, via the communication interface, to a sub audio device of at least one user from among the plurality of users,
operating in a third mode of controlling the display to display a second image corresponding to the plurality of items, controlling the communication interface to output, via the sub audio source, a second sounds corresponding to the plurality of items, controlling the audio device to output the second sound.

18. The method of claim 17, wherein the operating in the third mode comprises:
determining whether a selection signal indicating that at least one user has selected at least one item of subcontent from among the plurality of items has been received,
identifying the at least one item, based on the obtained selection signal,
controlling the display to display a third image included in the plurality of items, controlling the communication interface to output, via the sub audio device, the first sub-sound corresponding to the at least one item, and controlling the audio device to output the second sub-sound corresponding to one or more the remaining items of subcontent from among the plurality of items.

19. The method of claim 18, wherein the operating in the third mode comprises:
based on the selection signal and the first control signal have been received, controlling the display to display the second image, controlling the communication interface to stop outputting the first sub-sound via the sub audio device, and muting the first sub-sound.

20. A non-transitory computer-readable recording medium having instructions recorded thereon, which, when executed by at least one processor, cause the at least one processor to:
determine whether a display device and an external audio device are connected via a communication interface;
based on the display device not being connected to the external audio device, control the display device to operate in a first mode that controls the display device to display a first image corresponding to content and controls an audio device of the display device to output a first sound corresponding to the content;
based on the display device being connected to the external audio device, operate the display device in a second mode comprising that controls the display device to display the first image and controls the communication interface to output the first sound via the external audio device; and
based on the display device operating in the second mode, in response to receiving a first control signal indicating a request to stop outputting the first sound via the external audio device, control the display device to display the first image, control the communication interface to stop outputting the first sound via the external audio device, and mute the first sound.
